(19) United States
(12) Patent Application Publication
(10) Pub. No.: US 2026/0317064 A1
(43) Pub. Date: Oct. 15, 2026

(54) SYSTEM AND METHOD FOR PRODUCT TRACKING AND AUTONOMOUS ORDER FULFILLMENT

(71) Applicant: Fulfil Solutions, Inc., Mountain View, CA (US)

(72) Inventors: Gilad Almogy, Palo Alto, CA (US); Jason Kalus, Oakland, CA (US); Eric Yehl, San Francisco, CA (US); Michael Starkey, San Luis Obispo, CA (US); David Cameron Hosken, San Francisco, CA (US); Brock Csira, Saratoga, CA (US); Stephen Burke, New York, NY (US); Arni Lehto, Pittsburgh, PA (US); Nathan Beckett, Oakland, CA (US)

(21) Appl. No.: 19/641,992

(22) Filed: Apr. 8, 2026

Related U.S. Application Data
(60) Provisional application No. 63/786,141, filed on Apr. 9, 2025.

(51) Int. Cl. B65G 1/137; G06Q 10/087; G06V 10/40; G06V 20/68

(52) U.S. Cl. CPC B65G 1/1373; G06Q 10/08741; G06V 10/40; G06V 20/68

(57) ABSTRACT

One variation of a method includes, during a first time period: generating a product template for a product type that specifies product-handling parameters the product type; in response to a set of incoming product units of the product type entering the order fulfillment facility, accessing the product template; and selecting a tray for storing incoming product units in the set of incoming product units based on the product template. This variation of the method also includes, during a second time period succeeding the first time period: selecting the tray for fulfillment of an electronic order based on product-handling parameters specified in the product template; via the dispensing unit, dispensing a first product unit from the tray according to the electronic order; detecting a trigger to discard a second product unit; and, via the dispensing unit, dispensing the second product unit.

### CROSS-REFERENCE TO RELATED APPLICATIONS

This Application claims the benefit of U.S. Provisional Application No. 63/786,141, filed on 09-Apr-2025, which is incorporated in its entirety by this reference.

### TECHNICAL FIELD

This invention relates generally to the field of online order fulfillment operations and, more specifically, to a new and useful system and method for product tracking and autonomous order fulfillment in the field of online order fulfillment operations.

### BRIEF DESCRIPTION OF THE FIGURES

FIGS. 1A and 1B are flowchart representations of a method;

FIGS. 2A and 2B are flowchart representations of one variation of the method;

FIGS. 3A and 3B are flowchart representations of one variation of the method; and

FIG. 4 is a schematic representation of a system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

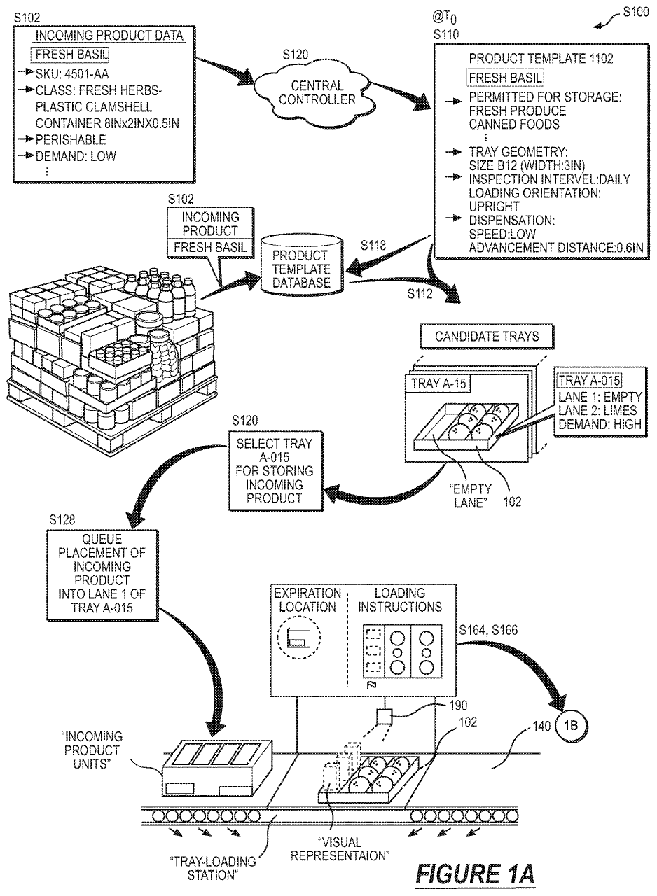

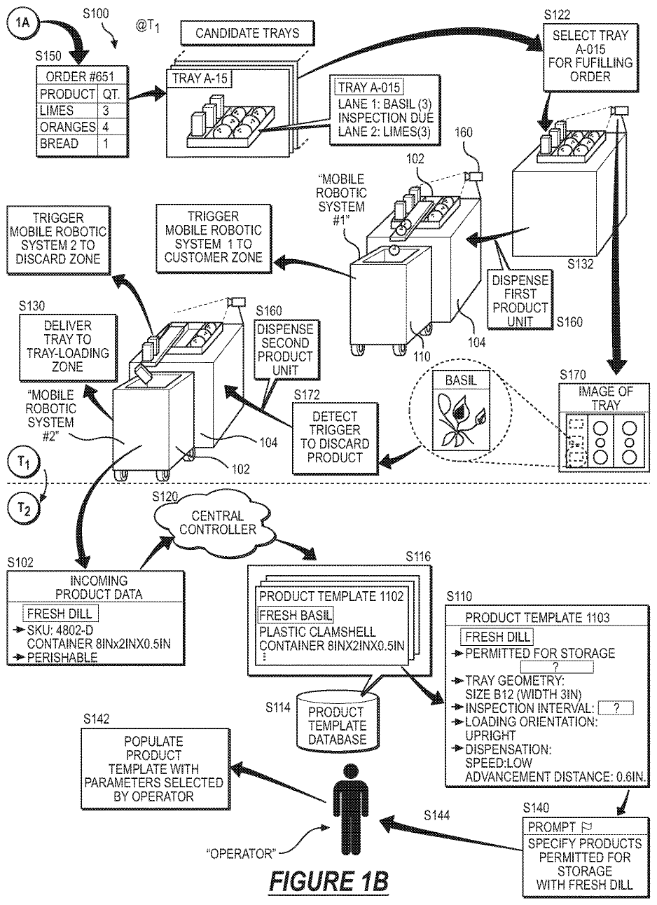

As shown in FIGS. 1A, 1B, 2A, 2B, 3A, 3B, and 4, a method S100 includes generating a first product template for a first product type that specifies product-handling parameters for product units of the first product type at an order fulfillment facility in Block S110. The method S100 also includes, during a first time period, in response to a first set of incoming product units of the first product type entering the order fulfillment facility, accessing the first product template for the first product type in Block S112; selecting a tray 102, from a population of trays, for storing incoming product units in the first set of incoming product units based on the first product template, the tray 102 including a first lane devoid of product units and a second lane storing product units of a second product type in Block S120; queuing placement of a first quantity of product units, in the first set of incoming product units, into the first lane of the tray 102 in Block S128; and, via a tray-routing system 140, navigating the tray 102 to a tray-loading station for loading of product units of the first product type into the first lane of the tray 102 in Block S130.

The method S100 also includes, during a second time period succeeding the first time period: accessing an electronic order specifying the second product type in Block S150; selecting the tray 102, from a set of trays loaded with product units of the second product type, for fulfillment of the electronic order and inspection of product units of the first product type based on product-handling parameters specified in the first product template in Block S122; via the tray-routing system 140, navigating the tray 102 to a dispensing unit 104 for dispensation of product units from the tray 102 in Block S132; dispensing a second product unit of the second product type from the second lane according to the electronic order via the dispensing unit 104 in Block S160; detecting a trigger to discard a first product unit of the first product type from the tray 102 in Block S172; and, in response to the trigger, dispensing the first product unit via the dispensing unit 104 in Block S160.

### 1.1 Variation: Tray Selection Based on Product Expiration

As shown in FIGS. 1A, 1B, 2A, 2B, 3A, and 3B, one variation of the method S100 includes, during a first time period: in response to a first set of incoming product units of a first product type entering an order fulfillment facility, accessing a first product template that specifies product-handling parameters for product units of the first product type at an order fulfillment facility in Block S112; assigning a first lane of a tray 102, in a population of trays, for storing incoming product units in the first set of incoming product units based on the first product template in Block S120; and, via a tray-routing system 140, navigating the first tray 102 to a tray-loading station for loading of a first quantity of product units, in the first set of incoming product units, into the first lane of the tray 102 in Block S130.

This variation of the method S100 also includes, during a second time period succeeding the first time period: accessing an electronic order specifying the first product type in Block S150; accessing an image depicting product units stored on the first tray 102 in Block S170; detecting a trigger to discard a second product unit from a second lane, adjacent the first lane, of the tray 102 based on features of the second product unit depicted in the image in Block S172; in response to detecting the trigger to remove the second product unit from the tray 102, selecting the tray 102, from a set of trays loaded with product units of the first product type, for fulfillment of the electronic order in Block S122; via the tray-routing system 140, navigating the tray 102 to a dispensing unit 104 for dispensation of product units from the tray 102 in Block S132; and, via the dispensing unit 104, dispensing a first product unit of the first product type from the first lane according to the electronic order and dispensing the second product unit from the second lane of the tray 102 in Block S160.

### 1.2 Variation: Opportunistic Product Inspection

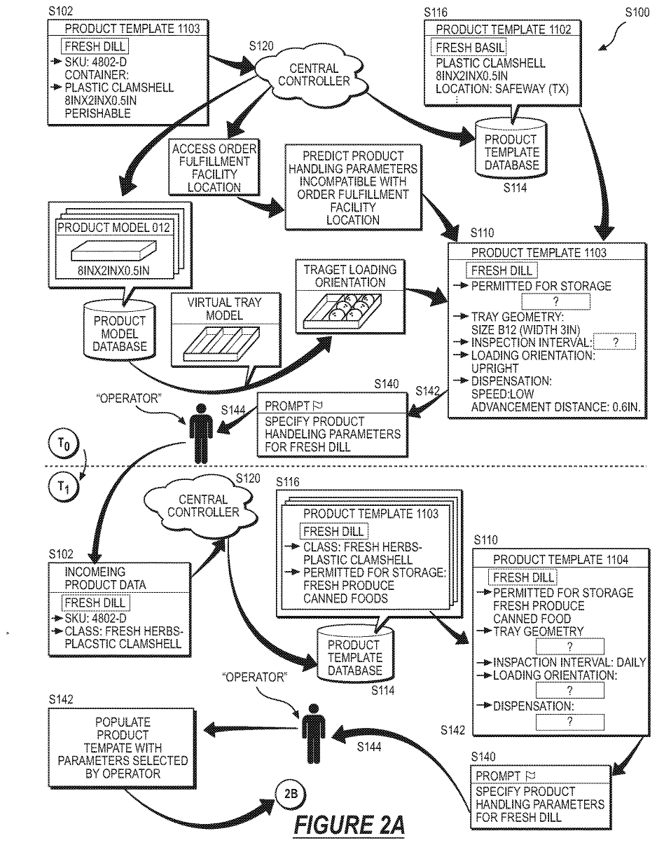

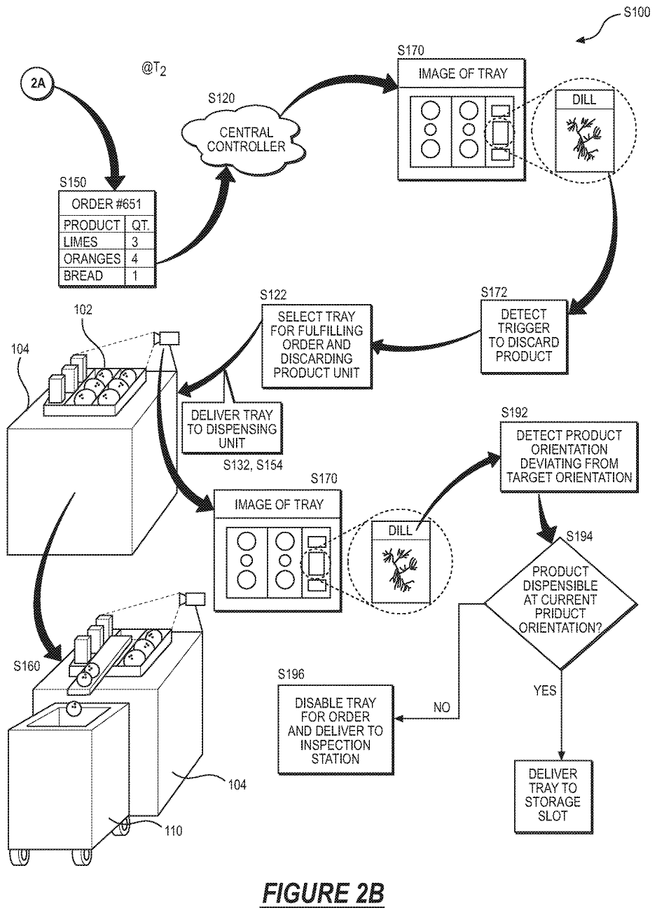

As shown in FIGS. 1A, 1B, 2A, and 2B, one variation of the method S100 includes, during a first time period: in response to a first set of incoming product units of a first product type entering an order fulfillment facility, accessing a first product template that specifies product-handling parameters for product units of the first product type at an order fulfillment facility in Block S112; assigning a first lane of a tray 102, in a population of trays, for storing incoming product units in the first set of incoming product units based on the first product template in Block S120; and queuing placement of a first quantity of product units, in the first set of incoming product units, into the first lane of the tray 102 in Block S128.

This variation of the method S100 also includes, during a second time period succeeding the first time period: accessing an electronic order specifying the first product type in Block S150; selecting the tray 102, from a set of trays loaded with product units of the first product type, for fulfillment of the electronic order in Block S122; assigning a dispensing unit 104, located within the order fulfillment facility, for dispensation of product units from the tray 102 in Block S154; via the dispensing unit 104, dispensing a first product unit of the first product type from the first lane according to the electronic order in Block S160; detecting a trigger to discard a second product unit from a second lane, adjacent the first lane, of the tray 102 in Block S172; and queuing discard of the second product unit from the tray 102.

### 1.3 Variation: Tray Selection Based on Product Perishability

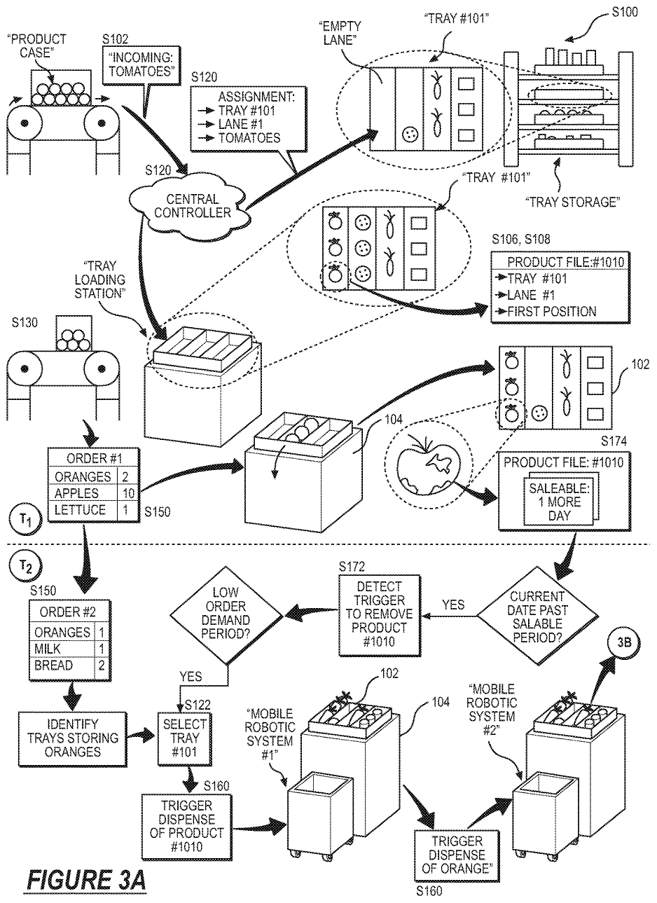

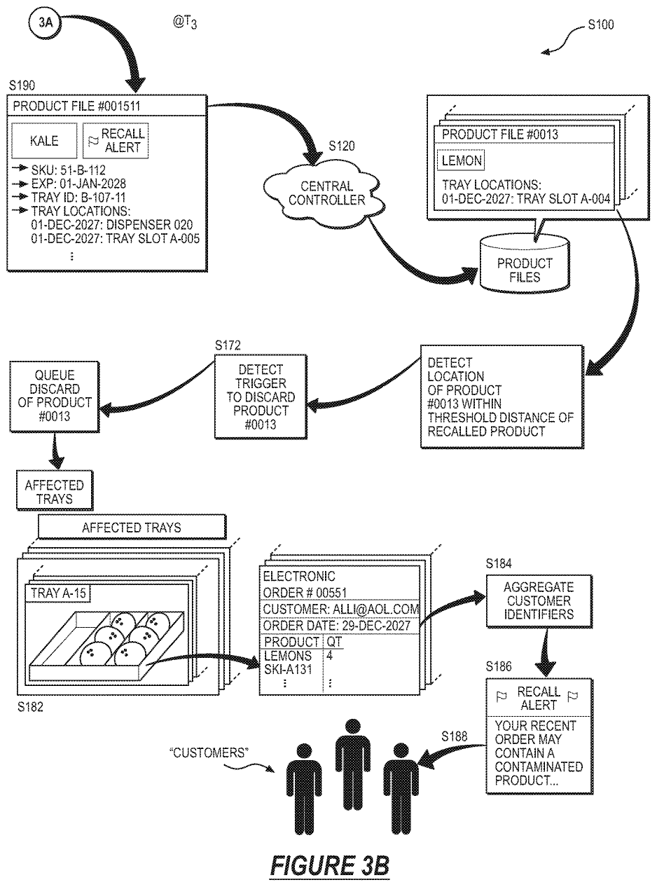

As shown in FIGS. 3A and 3B, one variation of a method S100 includes, during a first time period, accessing a first product type (e.g., tomatoes) of product units entering an order fulfillment facility (e.g., a grocery store stockroom), the first product type characterized by a high spoilage rate in Block S102. This variation of the method S100 further includes, during the first time period, identifying a first tray 102, in a population of trays, the first tray 102: devoid of product units in a first lane in a set of lanes of the first tray 102; and temporarily storing product units of a second product type (e.g., canned beans), different from the first product type and characterized by a high product demand, in a second lane, adjacent the first lane in the set of lanes.

This variation of the method S100 also includes, during the first time period: assigning the first lane of the first tray 102 to temporarily store a first quantity of product units of the first product type based on the high spoilage rate of the first product type and the high product demand of the second product type in Block S120; triggering a tray-routing system 140 to locate the first tray 102 in a tray-loading station for loading of product units of the first product type into the first lane of the first tray 102 in Block S130; and, for a first product unit of the first product type stored in the first lane, initializing a product unit file corresponding to the product unit in Block S106.

This variation of the method S100 further includes, during the first time period: receiving a first electronic order specifying product units of the second product type in Block S150; triggering the tray-routing system 140 to locate the first tray 102 in a dispensing unit 104 for dispensation of product units from the first tray 102 in Block S132; triggering the dispensing unit 104 to dispense product units of the second product type from the second lane of the first tray 102 according to the first electronic order in Block S160; and accessing an image captured by an optical sensor 160 proximal the dispensing unit 104 and depicting product units stored in the first tray 102 in Block S170. This variation of the method S100 further includes: deriving a remaining saleable period of the first product unit based on characteristics of the first product unit depicted in the image in Block S174; and storing the remaining saleable period in the product unit file.

### 1.4 Variation: Proactive Product Removal During Order Fulfillment

As shown in FIGS. 3A and 3B, one variation of the method S100 further includes, during a second time period succeeding the first time period: receiving a second electronic order specifying product units of the second product type in Block S150; identifying a set of trays, in the population of trays, temporarily storing product units of the second product type; detecting a trigger to remove the first product unit of the first product type from the first tray 102 based on expiration of the remaining saleable period of the first product unit in Block S172; and, in response to the first tray 102 storing product units of the second product type specified in the second electronic order and in response to detecting the trigger to remove the first product unit of the first product type from the first tray 102, selecting the first tray 102, from the set of trays, for dispensation of product units of the second product type according to the second electronic order in Block S122.

This variation of the method S100 further includes: triggering the tray-routing system 140 to locate the first tray 102 in the dispensing unit 104 for dispensation of product units from the first tray 102 in Block S132; triggering a first mobile robotic system 110 to maneuver to a loading zone proximal the dispensing unit 104; triggering the dispensing unit 104 to dispense the first product unit of the first product type from the first lane of the first tray 102 into the first mobile robotic system 110 in Block S160; triggering a second mobile robotic system 110 to maneuver to the loading zone proximal the dispensing unit 104; and triggering the dispensing unit 104 to dispense product units of the second product type from the second lane of the first tray 102, into the second mobile robotic system 110, according to the second electronic order in Block S160.

### 1.5 Variation: Tray Selection Based on Product Sensitivity

As shown in FIGS. 1A, 1B, 3A, and 3B, one variation of the method S100 further includes, during a second time period succeeding the first time period, receiving a second electronic order specifying product units of the second product type in Block S150. This variation of the method S100 further includes identifying the first tray 102 temporarily storing: product units of the first product type (e.g., tomatoes), characterized by the high spoilage rate, in the first lane of the first tray 102; and product units of the second product type (e.g., canned beans), characterized by the high product demand, in the second lane of the first tray 102. This variation of the method S100 also includes identifying a second tray 102 temporarily storing: product units of the second product type in a third lane of the second tray; and product units of a third product type (e.g., boxed pasta), characterized by a low spoilage rate, in a fourth lane of the second tray.

This variation of the method S100 further includes: in response to the first tray 102 storing product units of the second product type specified in the second electronic order and in response to the first tray 102 storing product units of the first product type characterized by the high spoilage rate, selecting the first tray 102 for dispensation of product units of the second product type according to the second electronic order in Block S122; triggering the tray-routing system 140 to locate the first tray 102 in the dispensing unit 104 for dispensation of product units from the first tray 102 in Block S132; and triggering the dispensing unit 104 to dispense product units of the second product type from the first lane of the first tray 102 according to the second electronic order in Block S160.

This variation of the method S100 also includes: accessing a second image captured by the optical sensor 160 proximal the dispensing unit 104 and depicting product units stored in the first tray 102 in Block S172; deriving a second remaining saleable period of the first product unit based on characteristics of the first product unit depicted in the second image in Block S174; and storing the second remaining saleable period in the product unit file.

### 1.6 Variation: Tray Selection Based on Real-time Order Demand

As shown in FIGS. 3A and 3B, one variation of the method S100 further includes, during a second time period succeeding the first time period: receiving a second electronic order specifying a first quantity of product units of the first product type in Block S150; in response to a quantity of unfulfilled orders, received at the order fulfillment facility, falling below a threshold quantity within a time interval, identifying a low-demand period at the order fulfillment facility during the time interval; and, in response to identifying the low-demand period, selecting the first tray 102 for dispensation of the first quantity of product units of the first product type according to the second electronic order, the first tray 102 temporarily storing the first quantity of product units of the first product type in the first lane of the first tray 102 in Block S122.

This variation of the method S100 further includes: triggering the tray-routing system 140 to locate the first tray 102 in the dispensing unit 104 for dispensation of product units from the first tray 102 in Block S132; triggering the dispensing unit 104 to dispense the first quantity of product units of the first product type from the first lane of the first tray 102 according to the second electronic order in Block S160; and, in response to assignment of the first lane of the first tray 102 to product units of a third product type (e.g., limes), different from the first product type, triggering the tray-routing system 140 to locate the first tray 102 in the tray-loading station for loading of product units of the third product type into the first lane of the first tray 102 in Block S130.

### 2. Applications

Generally, the method S100 can be executed by a central controller 120—in cooperation with a mobile robotic system 110, a tray-routing system 140, and a set of fixed cameras—deployed in an order fulfillment facility (hereinafter the “system 100”): to identify incoming product units of a product type entering the order fulfillment facility; to select a tray 102, from a population of trays, with an available (i.e., empty) lane for temporary storage of these incoming product units of the product type; to initialize storage of product metadata (e.g., a position of the product unit on the tray 102, a product intake date, product images) of each product unit loaded into the tray 102 in a product unit file corresponding to the product unit; to trigger the tray-routing system 140 to maneuver these trays throughout the order fulfillment facility according to inbound orders; to opportunistically capture images of these product units when these trays are delivered to dispensing units 104 in the order fulfillment facility for dispensation of other product units—also stored in these trays—according to inbound orders; to derive or extract characteristics (e.g., product quality, estimated remaining saleable time period) of these individual product units from these images; and to record these characteristics and other metadata (e.g., locations in the facility, proximity to other uniquely-identified product units) in individual product unit files corresponding to these individual product units.

The central controller 120 can thus generate, maintain, and update a product unit file for each product unit entering, stored, and dispensed from the store, including data such as: locations of a product unit throughout the facility over time, environmental conditions that a product unit is exposed to over time (e.g., temperature and humidity), and proximity of the product unit to other product units in the store over time based on tray maneuvers executed by the tray-routing system 140; weight and weight-derived price of the product unit (e.g., detected from a barcode scanned by an optical sensor or manual scanner at the tray-loading station during induction of the product unit); and ripeness, mold presence, color, size, damage, printed expiration date, and/or other visual characteristics of the product unit thus derived from images opportunistically captured by optical sensors 160 at or near dispensing units 104 when these trays are delivered to these dispensing units 104, such as for dispensation of other product units according to current inbound orders.

In particular, the central controller 120 can manage many (e.g., hundreds, thousands) trays, each containing multiple lanes, each lane configured to store one or multiple product units of one product type. More specifically, the central controller 120 can assign the same product type to lanes across many trays and can pair groups of product units of this product type with different combinations of other product types across these trays.

The central controller 120 can also coordinate distribution of product units within lanes of these trays 102, such as to increase frequency of data capture for more sensitive product types with shorter shelf lives (e.g., produce) and implement lower priority of data capture for less sensitive product types with longer shelf lives. Because the central controller 120 accesses images opportunistically captured by optical sensors 160 at dispensing units 104, the central controller 120 can selectively pair a higher-sensitivity product type with a higher-throughput (i.e., higher demand) product type such that product units of the higher-sensitivity product type are imaged—at dispensing units 104 —at a higher frequency corresponding to product unit calls of the higher-throughput product type (i.e., rather than at a lower frequency corresponding to product unit calls of the lower-throughput, higher-sensitivity product type).

For example, the central controller 120 can: pair avocados (i.e., a high-sensitivity product type) with bottled water (i.e., a high-throughput product type) in distinct lanes of a first tray 102; pair fresh berries (i.e., a high-sensitivity product type) with granola bars (i.e., a high-throughput product type) in distinct lanes of a second tray 102; and pair prepackaged salads (i.e., a high-sensitivity product type) with eggs (i.e., a high-throughput product type) in distinct lanes of a third tray. The central controller 120 can thus access images—and derive characteristics—of: avocados in the first tray 102 each time a bottle of water and/or an avocado is dispensed from the first tray 102; fresh berries in the second tray each time a granola bar and/or a package of fresh berries is dispensed from the second tray; prepackaged salads in the third tray each time a dozen eggs and/or a prepackaged salad is dispensed from the third tray.

Furthermore, to enable such high-sensitivity and high-throughput product type pairings (or otherwise sensitivity-and throughput-matched product type pairings) in distinct lanes of one tray, the central controller 120 can prioritize clearing (i.e., emptying) lanes in trays when selecting a particular tray—from many trays that may currently store a particular product specified in an inbound order—for fulfillment of the inbound order. The central controller 120 can then efficiently allocate a newly-emptied row in this tray to a new batch of product units of a product type characterized by a sensitivity and/or throughput rate matched to other product types occupying other lanes of the tray 102.

Additionally or alternatively, the central controller 120 can select a particular tray—from many trays that may currently store a particular product specified in an inbound order—for delivery to a dispensing unit 104 in order to: dispense a first product unit of a first product type according to the inbound order; and to access, dispense, and discard a second product unit that expired. The central controller 120 can thus call trays to the dispensing units 104 for both fulfillment of inbound orders and opportunistic discard of other expired, perished, or exposed product units.

Additionally or alternatively, the central controller 120 can call trays in sequences that decrease aggregate distances traversed by trays delivered to dispensing units 104 during high-demand periods, thereby enabling the facility to fulfill orders at higher frequency. Conversely, during lower-demand periods, the central controller 120 can call trays in sequences that increase counts of unique trays—storing product units of high-sensitivity product types—delivered to dispensing units 104, thereby enabling the central controller 120 to access images of a larger population of higher-sensitivity product units stored in the facility. Therefore, the central controller 120 can deviate from first-in, first-out stock management within the store in order to better match visibility of product units of higher-sensitivity product types to real-time demand and longer-term stock management needs.

Additionally, the central controller 120 can assign incoming product units across trays 102 in the population of trays such that a minimum number of trays 102 are routed to tray-loading stations to receive a given set of incoming product units, such that each tray 102 called to a tray-loading station receives a maximum quantity of incoming product units per trip. By minimizing the quantity of trays 102 routed to tray-loading stations, the central controller 120 can reduce traffic on the tray-routing system 140 during inbound operations, thereby increasing throughput on both inbound and outbound ends of the tray-routing system 140 simultaneously, while reducing labor per product unit loaded at each tray-loading station.

The central controller 120 can further sequence trays 102 delivered to tray-loading stations to match a queue of incoming product units advancing along a receiving conveyor toward the tray-loading station. For example, the receiving conveyor can include multiple parallel lanes, each lane advancing a distinct stream of incoming product units toward the tray-loading station, such that the central controller 120 can select a sequence of trays matching a route through the multiple parallel streams rather than a single fixed queue. By selecting tray sequences matched to multiple parallel streams of incoming product units, the central controller 120 can maintain a consistent queue of trays 102 at each tray-loading station, thereby reducing wait time between trays 102 for operators at the tray-loading station, while distributing routes to the tray-routing system 140 across inbound and outbound operations to reduce traffic for the tray-routing system 140.

### 2.1 Product Unit Ingest

In particular, at the order fulfillment facility, incoming product units (e.g., product units delivered proximal to an unloading dock) may be loaded into a population of trays (i.e., configured to temporarily store product units) at a tray-loading station. In particular, incoming product units (e.g., grocery items, apparel items, or consumer goods) can be loaded into a particular tray and arranged in a single layer (e.g., not stacked atop one another), such that each product unit stored in the tray 102 is unobstructed and detectable by an overhead optical sensor 160 (e.g., for product identification and inspection). More specifically, incoming product units can be arranged in a single layer, such that every product unit may be inspected (i.e., rather than inspecting a random sampling of incoming product units).

Upon loading product units into a tray 102, the tray-routing system 140 can maneuver the tray 102 through a tray-routing network (e.g., a series of cranes and/or conveyors) arranged downstream of the tray-loading station. In particular, the tray-routing system 140 can locate the tray 102 in: a storage slot, in a set of storage slots, configured to temporarily store the tray 102; and/or a dispensing unit 104, in a population of dispensing units 104, configured to selectively dispense products from the tray 102. Thus, the central controller 120 can track individual product unit movements between each location in the order fulfillment facility and store these movements in the corresponding product unit file. By tracking individual product units, the system 100 can: maintain real-time location data for each product unit throughout the order fulfillment facility; and reconstruct an audit trail to trace the movement and status of each product unit from induction to dispensation.

Additionally, by maintaining unit-level inventory counts, the central controller 120 can derive an exact quantity of each product type in stock at any given time (e.g., rather than an estimated quantity) such that the central controller 120 can fulfill electronic orders without substitutions and can calculate precise restocking quantities for each product type based on current inventory counts, derived shelf lives, and sales projections for each product type, thereby reducing over-ordering that accelerates spoilage and under-ordering that results in unfulfilled orders.

### 2.2 Product-handling Parameters+Onboarding New Product Types

In particular, the system 100 is configured to ingest, store, and dispense a population (e.g., hundreds, thousands) of unique product types that each exhibit unique dimensions, packaging types, expiration rules, inspection schedules, temperature needs, and food storage constraints. Accordingly, the central controller 120 can generate a product template for each product type that specifies unique product-handling parameters for the product unit, such as compatible tray geometries, permitted co-location with other product types, preferred loading orientations, quantities of product units that can be stored within tray lanes, and parameters governing autonomous dispensing of the product units. More specifically, the central controller 120 can derive these product-handling parameters prior to storage of product units within the system such that, once product units are loaded into trays and enter automated storage, the system can reliably store, inspect, and dispense the product units without requiring additional manual intervention or reconfiguration. The central controller 120 can then store this product template in a product template database containing a population of product templates.

The central controller 120 can then, for a new product type, scan this product template database for product templates corresponding to similar product types and selectively populate product-handling parameters from these existing product templates into a new product template for this new product type. For example, based on available data (e.g., a packaging type, a SKU, a product classification, dimensions) for a new product type, the central controller 120 can selectively identify one or more existing product templates corresponding to similar product types and copy a subset of product-handling parameters (e.g., lane geometry, loading orientation, or dispensation parameters) from these existing product templates. Accordingly, rather than manually configuring all storage and dispensing rules for each new product type, the central controller 120 can reuse compatible handling parameters from existing product templates (and selectively derive or request operator input only for remaining parameters). Therefore, the central controller 120 can reduce operator workload during product onboarding, reduce computational overhead associated with generating product-handling parameters, and accelerate onboarding of new product types while maintaining correct storage, inspection, and dispensing behavior within the order fulfillment facility.

### 2.3 Order Fulfillment

During fulfillment of an electronic order (i.e., when product units are dispensed from a tray 102) the central controller 120 can execute an inspection cycle (i.e., at the dispensing unit 104) to detect product quality of the remaining product units in the tray 102. In particular, the central controller 120 can: access an image depicting product units, arranged in a single layer, on the tray 102; detect characteristics of each product unit, such as ripeness and/or visual indicators of spoilage (e.g., mold, discoloration, bruising); and derive a remaining saleable period of each product unit. The central controller 120 can then append this inspection data to the corresponding product unit file to update the product metadata to reflect changes in quality, expected shelf life, and any detected defects.

### 2.4 Spoiled Product

In response to detecting a product unit exhibiting characteristics indicating imminent spoilage, the system 100 can flag the unit for removal or prioritize retrieval of the tray 102 containing the product unit for immediate fulfillment. More specifically, upon receiving an electronic order specifying product units of a target product type stored in the tray 102, the central controller 120 can select the tray 102 for dispensation. For example, the central controller 120 can: trigger dispensation of product units of the target product type into a first mobile robotic system 110; and trigger dispensation of the spoiled product unit into a second mobile robotic system 110 following dispensation of product units of the target product type.

Thus, the central controller 120 can execute an inspection cycle during each dispensation event to construct a comprehensive record for each product unit throughout the lifecycle of the product unit within the facility, from intake to storage and fulfillment. By tracking product units throughout the order fulfillment facility and constructing these product records, the central controller 120 can: prioritize inventory rotation and dispensation based on real-time product condition and remaining shelf life; identify and remove spoiled product units (or product units nearing expiration) prior to these product units contaminating adjacent inventory; anticipate restocking needs by monitoring product depletion rates and shelf life trends; and rapidly trace affected product units in the event of a product recall, based on recorded inspection data, product movements, intake dates, and storage history.

### 3. Storage Racks+Trays

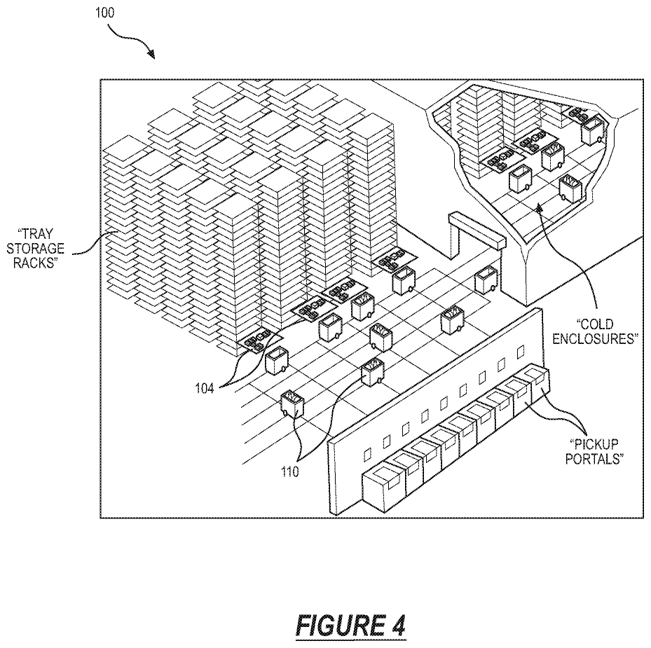

In one implementation, as shown in FIG. 4, the order fulfillment system includes: a population of trays configured to temporarily store product units; and a set of storage racks configured to temporarily store the population of trays. In particular, each storage rack defines a set of storage slots, each storage slot in the set of storage slots configured to store an individual tray. The set of storage slots can be vertically spaced apart from adjacent storage slots by a set pitch distance, such that a particular tray can occupy one or more adjacent storage slots based on a product height of product units stored in the tray 102.

Each tray can include a set of supports: projecting upward from a base of the tray 102; defining a set of lanes within the tray 102; and configured to support product units within the set of lanes. Each lane of the tray 102 can be loaded with product units of a particular product type. Additionally, each tray 102 can be loaded with multiple unique product types, wherein each unique product type is stored within one or more lanes of the tray 102. In particular, the population of trays can include multiple tray types, each tray type configured to store products of different widths. For example, a first tray 102 can include a set of ten lanes configured to store product units of a particular product type exhibiting a relatively narrow product width, such as lemons. Alternatively, a second tray 102 can include a set of three lanes configured to store product units of a particular product type exhibiting a relatively wide product width, such as cereal boxes.

In one implementation, the order fulfillment system can assign product units of a single product type to each lane in the set of lanes of a particular tray. In one variation, the order fulfillment system can assign product units of the same product type to multiple tray types based on product orientation (e.g., assigning a spaghetti box to a first tray type when the long axis of the product unit is aligned with the lanes, and to a second tray type when the long axis is perpendicular to the lanes). In another variation, the order fulfillment system can assign multiple product types to a single lane of a tray 102, such that individual lanes can accommodate heterogeneous groupings of product units. For example, the order fulfillment system can assign a single lane to store both apples and oranges when both product types satisfy predefined compatibility conditions, such as matching storage regulation categories or similar physical dimensions. Thus, the order fulfillment system can assign product units to different tray types to increase flexibility in product storage and maximize the quantity of trays eligible for storing a particular product type based on real-time inventory conditions and orientation constraints.

### 4. Induction Zone+Tray-loading Stations

In one implementation, the order fulfillment system includes a set of tray-loading stations configured to transiently receive the population of trays for loading (e.g., manual or autonomous loading) of incoming product units. For example, the set of tray-loading stations can be arranged downstream of an induction zone, such as an unloading dock where incoming product cases are delivered to the order fulfillment facility. In particular, each tray-loading station can be configured to: receive an incoming product case containing product units of a particular product type; and receive a tray 102, in the population of trays, assigned to temporarily store product units from the incoming product case. Each tray-loading station can include a user interface configured to display predefined loading instructions for loading product units into the tray 102. In one variation, each tray-loading station can be configured to project a visual representation of a particular product type within a lane of a tray 102 (e.g., via an overhead projector) to visually cue the specific lane and orientation for loading the product units into the lane.

For example, a first conveyor can be configured to deliver a particular tray to the tray-loading station, and a second conveyor can be configured to deliver a product case, containing incoming product units assigned to the particular tray, to the tray-loading station, such that the tray 102 and the product case arrive at the tray-loading station at approximately the same time. In this example, an operator may then visually inspect each product unit upon loading the incoming product unit into the tray 102. Accordingly, the order fulfillment system can synchronize the arrival of the tray 102 and the corresponding product case at the tray-loading station and render specific, lane-level loading instructions through the user interface to streamline tray loading operations and reduce decision-making required by the operator.

### 5. Dispensing Units

In one implementation, the order fulfillment system includes a set of dispensing units 104 configured to transiently receive the population of trays and dispense product units temporarily stored within the population of trays. In particular, each dispensing unit 104 faces a loading zone and is configured to: receive a tray 102 in the population of trays; and selectively dispense individual product units from the tray 102 toward the loading zone. For example, each dispensing unit 104 in the set of dispensing units 104 can include a set of dispensing arms configured to: pass through an opening of the tray 102 toward the set of supports; elevate through a lane defined between a pair of supports in the set of supports to lift a row of product units, stored in the lane between the pair of supports, above the lane; and drive the row of product units, temporarily stored within the lane, forward toward the loading zone.

### 6. Tray-routing System

In one implementation, the order fulfillment system includes a tray-routing system 140 configured to transfer the population of trays between the set of storage racks, the set of tray-loading stations, and the set of dispensing units 104. In particular, the tray-routing system 140 is configured to: retrieve a tray 102 (e.g., a partially-loaded tray stored in a storage slot or an empty tray); maneuver the tray 102 through a tray-routing network (e.g., a series of conveyors) to locate the tray 102 within a tray-loading station, in the set of tray-loading stations, assigned to the tray 102 for loading of product units into the tray 102 (or a particular lane of the tray 102); and deliver the tray 102, loaded with product units, to a storage slot in the set of storage slots of the storage rack for temporary storage of the tray 102. Additionally, the tray-routing system 140 is configured to: retrieve the tray 102 from the storage slot; maneuver the tray 102 through a tray-routing network to locate the tray 102 within a dispensing unit 104, in the set of dispensing units 104, assigned to the tray 102 for dispensation of product units temporarily stored in the tray 102; and return the tray 102 to the storage slot for temporary storage of the tray 102.

### 7. Mobile Robotic System

In one implementation, the order fulfillment system includes a population of mobile robotic systems 110 configured to autonomously maneuver through the order fulfillment facility to fulfill customer orders (or “orders”). In one implementation, each mobile robotic system 110 includes a local controller configured to receive a fulfillment command, associated with an electronic order, from the central controller 120. In particular, the local controller is further configured to, based on the fulfillment command: trigger the mobile platform to autonomously navigate to a loading zone adjacent a dispensing unit 104 loaded with a tray 102 containing product units of a target product type specified in the electronic order; trigger the mobile platform to autonomously align to the dispensing unit 104 to receive a product unit of the target product type; and trigger the mobile platform to autonomously navigate to an unloading zone within the order fulfillment facility for retrieval or removal of product units from the mobile robotic system 110. For example, each mobile robotic system 110 can be configured to receive product units within a product container transiently loaded into the mobile robotic system 110.

### 8. Suite of Optical Sensors

In one implementation, the order fulfillment system includes a suite of optical sensors 160 (e.g., hyper-spectral cameras, color cameras, LIDAR sensors, depth sensors, two-dimensional cameras, or three-dimensional cameras) arranged throughout the order fulfillment facility and configured to capture images (e.g., hyper-spectral images, two-dimensional color images, stereoscopic color images, depth maps) of product units stored in the population of trays. In particular, the order fulfillment system can include a set of (i.e., one or more) optical sensors 160 arranged at each tray-loading station, each dispensing unit 104, and/or a designated inspection station. In one example, each dispensing unit 104 can include: a hyper-spectral camera configured to capture hyper-spectral images; and a color camera configured to capture two-dimensional color images.

### 9. Central Controller

In one implementation, the order fulfillment system includes a central controller 120 (e.g., a remote controller, a remote computer system) configured to trigger actions by the set of dispensing units 104, the tray-routing system 140, and the population of mobile robotic systems 110. In particular, the central controller 120 is configured to: access images captured by the suite of optical sensors 160; interpret these images to detect product quality of product units temporarily stored within each lane of the tray 102; and trigger removal of product units stored in the tray 102 based on these images.

Additionally, the central controller 120 is configured to: receive an electronic order specifying a quantity of product units of a target product type; and identify a tray 102, in the population of trays, temporarily storing product units of the target product type. The central controller 120 is further configured to generate the fulfillment command associated with the electronic order and specifying: the mobile robotic system 110; the tray 102; the dispensing unit 104; and dispensation of the quantity of product units of the target product type from the tray 102 into the mobile robotic system 110 occupying the loading zone proximal the dispensing unit 104. The central controller 120 is further configured to disseminate the fulfillment command to the mobile robotic system 110.

### 10. Product Induction+Product Template Generation

Blocks of the method S100 recite: accessing a set of product metadata (e.g., a product classification and a set of physical characteristics) of a product type in Block S102; deriving a set of storage parameters and a set of dispensation parameters for product units of the product type based on the set of product metadata; generating a product template for a product type that specifies product-handling parameters (e.g., storage parameters and dispensation parameters) for product units of the product type at an order fulfillment facility in Block S110; and storing the product template in a product template database containing a population of product templates in Block S118.

Generally, in Block S110, the central controller 120 can generate a product template for the product type that specifies parameters for storing and handling incoming product units, such as compatible tray geometries, permitted co-location with other product types, preferred loading orientations, quantities of product units that can be stored within tray lanes, and parameters governing autonomous dispensing of the product units. Then, in response to product units of this product type entering the order fulfillment facility, the central controller 120 can retrieve this product template to assign trays, configure loading of the product units into lanes of trays, and control dispensing of the product units during order fulfillment, as described below. In particular, by specifying these parameters in the product template, the central controller 120 can consistently handle product units of the product type during storage, inspection, and dispensing operations within the order fulfillment facility.

In one implementation, as shown in FIGS. 1A and 1B, to generate a new product template for a new product type (i.e., a product type not previously stored or handled within the order fulfillment facility), the central controller 120 can retrieve product metadata (e.g., physical characteristics and a product classification) corresponding to the product type, such as from a product catalog maintained by the order fulfillment facility, a retailer product database, or a supplier product information database. In particular, the central controller 120 can access a product classification (e.g., produce, beverage, dairy product, cleaning product, or packaged dry good) and a set of physical characteristics of the product type, such as dimensions (e.g., width, height, maximum dimension, or form factor), a packaging type (e.g., rigid container, flexible package, bottle, carton, or clamshell container), weight, packaging rigidity, and/or center-of-mass characteristics.

In one implementation, based on the set of physical characteristics and the product classification, the central controller 120 can derive a list of product types permitted for storage with the product type based on: the product classification (e.g., corresponding to regulatory requirements, contamination restrictions, or product handling policies associated with the order fulfillment facility); and/or physical characteristics of the product type, such as to store product units with similar physical profiles within adjacent lanes of a tray 102 and thereby reduce inefficient use of vertical storage space within storage racks. Additionally, the central controller 120 can derive a target loading orientation for product units of the product type based on the set of physical characteristics of the product type, such as by identifying an upright orientation for product units exhibiting rigid packaging or identifying a horizontal orientation for elongated containers.

In another implementation, the central controller 120 can derive a lane geometry compatible with the product type based on the set of physical characteristics of the product type. In particular, the central controller 120 can identify tray configurations within the population of trays that include lanes exhibiting widths, depths, and heights compatible with the dimensions of the product units, such as by selecting trays containing adjustable lane dividers or modular lane structures configured to accommodate different product geometries.

Additionally, the central controller 120 can derive a set of dispensation parameters for autonomous dispensation of product units of the product type based on the set of physical characteristics. In particular, the central controller 120 can derive dispensation parameters based on packaging type, product dimensions, and capabilities of dispensing units 104 within the order fulfillment facility, such as parameters specifying dispensing arm positions, dispensing force thresholds, and allowable product orientations for reliable dispensing of product units from tray lanes. For example, for a product unit packaged in a glass bottle including a neck region, the central controller 120 can derive dispensation parameters that prevent dispensation of the glass bottle (e.g., into a mobile robotic system 110) onto the neck region.

In one implementation, the central controller 120 can then generate the product template specifying: the product metadata (e.g., physical characteristics and a product classification); the list of product types permitted for storage with the product type; the lane geometry compatible with the product type; and the set of dispensation parameters. The central controller 120 can then store the product template in a product template database containing a population of product templates.

In one variation, Block S166 of the method S100 recites presenting the location of the expiration date to an operator via a user interface at the tray-loading station. In this variation, the central controller 120 can generate the product template further specifying a location of an expiration date on packaging of product units of the product. In particular, in this variation, the central controller 120 can identify the location of the expiration date on the packaging of the product units based on product metadata, historical template data for similar product types, or product packaging information stored in a product catalog. The central controller 120 can store this location in the product template such that the system 100 can guide operators during product induction to quickly locate the expiration date on each product unit. The central controller 120 can then retrieve the stored expiration-date location from the product template during induction of product units of the product type into the order fulfillment facility. For example, in response to presence of a tray 102 (i.e., assigned to the incoming product units) and the set of incoming product units at the tray-loading station, the central controller 120 can present the location of the expiration date to an operator via a user interface at the tray-loading station. Therefore, the central controller 120 can generate and store product templates that specify handling parameters and product-specific metadata prior to storage of product units in the system 100, such that the system 100 can rapidly and consistently configure storage, inspection, and dispensing operations for newly-introduced product types.

### 10.1 Product Template Generation from Existing Templates

In one variation, Blocks of the method S100 recite: accessing a first set of physical characteristics of a first product type of a first set of incoming product units entering the order fulfillment facility in Block S102; accessing a product template database containing a population of product templates in Block S114; scanning the product template database for product templates labeled with physical characteristics matching the first set of physical characteristics in Block S116; and, in response to correspondence between the first set of physical characteristics and a second set of physical characteristics of a second product type, populating a first product template for the first product type with a lane geometry and a set of dispensation parameters specified in a second product template for the second product type in Block S142. In this variation, Blocks of the method S100 also recite, in response to absence of a first product classification of the first product type: generating a prompt to specify a list of product types permitted for storage with the first product type in Block S140; serving the prompt to an operator via a user interface at the tray-loading station in Block S144; and populating the first product template with the list of product types specified by the operator in Block S142.

In this variation, the central controller 120 can: access product metadata (e.g., physical characteristics and a product classification) for a product type of new product units entering the facility; scan the product template database for product templates labeled with product metadata matching or similar to product metadata of the new product type; identify a candidate product template corresponding to a product type exhibiting the highest correspondence between physical characteristics; copy a subset of product-handling parameters (e.g., lane geometry and dispensation parameters) from the candidate product template to a new product template for the new product type; and request operator input to populate remaining product-handling parameters. For example, the central controller 120 can: generate a prompt to specify product-handling parameters (e.g., a list of product types permitted for storage with the new product type); in response to presence of a tray 102 and a set of incoming product units (i.e., assigned to the tray 102) at the tray-loading station, serve the prompt to an operator via a user interface at the tray-loading station; and populate the new product template with product-handling parameters specified by the operator.

In one example, the central controller 120 can: access a first set of physical characteristics (e.g., bottle height, diameter, and packaging rigidity) of a 2-liter soda bottle of a first brand (i.e., a first product type) of a first set of incoming product units entering the order fulfillment facility; and scan the product template database for product templates labeled with physical characteristics matching or similar to the first set of physical characteristics. The central controller 120 can then: identify a second product template for a second product type labeled with a second set of physical characteristics (e.g., bottle height, diameter, and packaging rigidity) of a 2-liter soda bottle of a second brand matching the first set of physical characteristics; and populate a first product template for the 2-liter soda bottle of the first brand with a lane geometry (e.g., a lane width and depth configured to store upright 2-liter bottles) and a set of dispensation parameters (e.g., parameters specifying dispensing contact at a body portion of the bottle) specified in the second product template for the second product type.

Additionally, in this example, in response to absence of a first product classification of the first product type (or in response to the first product classification deviating from a second product classification of the second product type), the central controller 120 can: generate a prompt to specify a list of product types permitted for storage with the first product type; and serve the prompt to an operator via a user interface at the tray-loading station.

In another example, the central controller 120 can: access a first product classification (e.g., refrigerated beverage) of bottled iced tea (i.e., a first product type) of a first set of incoming product units entering the order fulfillment facility; and scan the product template database for product templates labeled with product classifications matching the first product classification. The central controller 120 can then: identify a second product template for a second product type labeled with a second product classification (e.g., refrigerated beverage) of bottled juice (i.e., a second product type) matching the first product classification; and populate a first product template for the bottled iced tea with a list of product types, permitted for storage with the second product type, specified in a second product template for the bottled juice. Additionally, in this example, in response to absence of a first set of physical characteristics of the first product type (or in response to the first set of physical characteristics deviating from a second set of physical characteristics of the bottled juice), the central controller 120 can prompt the operator to specify a set of dispensation parameters for the first product type.

In one variation, the central controller 120 can: access an image captured by an optical sensor 160 at the order fulfillment facility, the image depicting a set of incoming product units (e.g., at the induction zone); detect a set of physical characteristics of the product type based on the image; generate an embedding encoding the set of physical characteristics of the product type; access a product model database containing a population of embeddings, each embedding encoding a set of physical characteristics of a product type and a lane geometry compatible with the product type; identify a historical embedding, in the population of embeddings, characterized by a shortest distance to the embedding; and populate a new product template for the product type with a lane geometry embedded in the embedding.

In another variation, the central controller 120 can: access a product classification (e.g., a SKU) of a new product type; retrieve a product description of the new product type from a product catalog (e.g., a website) associated with a manufacturer of the new product type; extract a set of natural language descriptors of the new product type from the product description; identify an existing product type associated with the manufacturer of the new product type; and map product-handling parameters from an existing product template for the existing product type to a new product template for the new product type based on correspondence between the set of natural language descriptors of the new product type and a set of natural language descriptors of the existing product type.

Thus, rather than manually configuring all storage and dispensing rules for each new product type, the central controller 120 can reuse compatible handling parameters from existing product templates and request operator input only for parameters that cannot be automatically derived, thereby accelerating onboarding of new product types while maintaining correct storage and dispensing behavior within the order fulfillment facility.

### 10.2 Interpreted Product-handling Parameters

In one variation, Blocks of the method S100 recite: accessing a first set of physical characteristics and a first product classification of a first product type of a first set of incoming product units entering the order fulfillment facility in Block S102; in response to correspondence between the first product classification and a second product classification of a second product type, populating a first product template for the first product type with a set of storage parameters specified in a second product template for the second product type in Block S142; and, in response to the first set of physical characteristics deviating from a second set of physical characteristics of the second product type, deriving a set of dispensation parameters for autonomous dispensation of product units of the first product type based on the first set of physical characteristics in Block S142.

In this variation, the central controller 120 can: implement methods and techniques described above to identify an extant product template, stored in the product template database, for an extant product type similar (or identical) to a new product type; map a subset of product-handling parameters from the extant product template to a new product template for the new product type; and automatically derive remaining product-handling parameters for the product type, such as by interpolating extant product-handling parameters specified for extant product types and stored in the product template database.

In one example, the central controller 120 can: implement methods and techniques described above to identify a second product template, stored in the product template database, for a second product type (e.g., a 2-liter soda bottle of a first brand) exhibiting similar (or identical) physical characteristics to a first product type (e.g., a 2-liter soda bottle of a second brand); and populate a first product template for the first product type with a lane geometry (e.g., a lane width and lane depth sized to receive upright 2-liter bottles) and a set of dispensation parameters (e.g., parameters specifying contact at a body portion of the bottle and dispensing in an upright orientation) specified in the second product template.

Additionally, in this example, in response to a first product classification (e.g., refrigerated beverage) of the first product type deviating from a second product classification (e.g., shelf-stable beverage) of the second product type, the central controller 120 can: derive a list of product types (e.g., refrigerated beverages or other chilled products) permitted for storage with the first product type based on the first product classification; and populate the first product template with the list of product types. For example, the central controller 120 can: query the product template database for product templates labeled with physical characteristics matching the first product type; retrieve a closest candidate product template; and map a subset of product-handling parameters from the candidate product template into the first product template. In another example, the central controller 120 can implement methods and techniques described above to: map storage parameters, specified in an extant product template, to a new product template; and derive a set of dispensation parameters for autonomous dispensation of product units of the new product type (e.g., different from dispensation parameters for the extant product type). Thus, in this variation, rather than re-generating product-handling parameters for a new product type, the central controller 120 can selectively reuse extant product-handling parameters from stored product templates, thereby reducing resources allocated to template-generation and accelerating onboarding of new product types.

### 10.3 Facility-Specific Product Template Adaptation

In one variation, as shown in FIG. 2A, the central controller 120 can adapt product templates based on a facility profile associated with the order fulfillment facility. In particular, the facility profile can specify location-specific conditions and facility-specific operational preferences that influence how products should be stored and handled within the facility. For example, the facility profile can specify environmental conditions (e.g., temperature ranges, humidity levels, or climate characteristics), equipment capabilities (e.g., available dispensing mechanisms or tray configurations), and operational policies (e.g., product co-location preferences, inspection frequencies, or preferred storage configurations).

In this variation, the central controller 120 can implement methods and techniques described above to: scan the product template database for product templates labeled with product metadata matching a first set of product metadata of a first product type; and, in response to correspondence between the first set of product metadata and a second set of product metadata of a second product type, access a second set of product-handling parameters specified in a second product template for the second product type.

The central controller 120 can then: access a facility profile associated with the order fulfillment facility that specifies facility-specific storage preferences, such as preferred temperature-controlled storage policies, permitted product co-location policies, or preferred tray configurations; populate a new product template for the first product type with a subset of product-handling parameters specified in the second product template that are compatible with the facility profile; predict a subset of product-handling parameters specified in the second product template that are incompatible with the facility profile; and derive or request operator input for these product-handling parameters.

In one example, the central controller 120 can: access a set of characteristics (e.g., a warm or hot climate region) associated with the order fulfillment facility; implement methods and techniques described above to identify an extant product template, stored in the product template database, for an extant product type (e.g., a packaged chocolate product) similar (or identical) to a new product type (e.g., a chocolate candy bar of a different brand); and access a set of product-handling parameters specified in the extant product template for the extant product type. The central controller 120 can then predict a first subset of product-handling parameters, in the set of product-handling parameters, incompatible with storage at the order fulfillment facility based on the set of characteristics of the order fulfillment facility. In particular, the central controller 120 can: access a set of characteristics associated with the order fulfillment facility; and identify product-handling parameters in the extant product template derived for facilities operating under different environmental conditions. More specifically, the central controller 120 can compare environmental characteristics and operational preferences specified in the facility profile with environmental assumptions associated with the extant product template to identify parameters that may not apply to the current facility. For example, the central controller 120 can predict a first subset of product-handling parameters including storage temperature ranges, preferred storage rack assignments, inspection intervals, or dispensing parameters associated with temperature-sensitive products that are incompatible with storage conditions at the order fulfillment facility.

Additionally, the central controller 120 can: predict a second subset of product-handling parameters, in the set of product-handling parameters (i.e., excluding the first subset of product-handling parameters), compatible with storage at the order fulfillment facility; and populate a new product template for the new product type with the second subset of product-handling parameters. Furthermore, in this example, the central controller 120 can: generate a prompt to specify product-handling parameters in the first subset of product-handling parameters; and serve the prompt to an operator (e.g., via a user interface at the tray-loading station). Thus, in this variation, the central controller 120 can reuse compatible product-handling parameters from existing product templates while adapting or replacing parameters that are incompatible with the conditions or preferences of the current order fulfillment facility, such as to efficiently onboard new product types across different facilities.

### 10.4 Target Loading Configuration+Product Model

In one variation, the central controller 120 can: maintain a product model database containing a population of virtual product models; scan the product model database for virtual product models labeled with physical characteristics matching a set of physical characteristics of a new product type entering the order fulfillment facility; and implement a previously-generated product model to derive storage and/or dispensation parameters for the new product type. In particular, the product model database can contain virtual representations of product types that capture geometric characteristics, mass distribution, packaging rigidity, and other physical attributes relevant to storage and autonomous dispensing within the order fulfillment facility.

In this variation, the central controller 120 can: detect correspondence between the physical characteristics of a new product type and those of previously modeled product types; and implement (i.e., reuse) an extant virtual model rather than generating a new model for the new product type. More specifically, the central controller 120 can access these virtual models to: simulate interactions between product units and tray geometries; derive stable loading orientations for product units within tray lanes; derive quantities of product units that can be accommodated within a lane; and derive dispensing parameters compatible with the autonomous dispensing units 104. For example, upon detecting that a new product type (e.g., a 2-liter soda bottle) exhibits physical characteristics matching (or similar to) those of a previously-modeled product type (e.g., a 2-liter soda bottle of a different brand), the central controller 120 can retrieve the corresponding virtual model and derive loading orientations, lane capacity, and/or dispensing parameters for the new product type based on the retrieved virtual model.

In particular, in this variation, the central controller 120 can: access a new set of physical characteristics of a new product type; access the product model database containing a population of virtual product models labeled with physical characteristics of product types; scan the product model database for virtual product models labeled with physical characteristics matching the new set of physical characteristics of the new product type; and, in response to correspondence between the new set of physical characteristics and a set of physical characteristics of an extant product type, access an extant virtual model associated with the extant product type.

The central controller 120 can then access a virtual tray model of a virtual tray that represents geometries of virtual lanes and corresponds to a real tray in the population of trays. In particular, the central controller 120 can: implement methods and techniques described above to derive a lane geometry compatible with the new product type; and access a virtual tray model of a virtual tray that represents a virtual lane exhibiting the lane geometry. Then, based on the virtual model of the extant product unit and the virtual tray model, the central controller 120 can derive: a target loading orientation for loading product units of the new product type into a lane of a real tray exhibiting the lane geometry; and a target quantity of product units of the new product type to store in the lane. Thus, in this variation, by retrieving and implementing an extant virtual product model, the central controller 120 can derive loading orientations and lane capacities for the new product type without generating a new product model, thereby reducing computational overhead and accelerating configuration of storage and dispensing parameters for newly introduced product types.

### 11. Tray Assignment for Incoming Products

Blocks of the method S100 recite: selecting a tray 102, from a population of trays, for storing incoming product units in a set of incoming product units based on a product template for the product type of the set of incoming product units in Block S120; and queuing placement of a quantity of product units, in the set of incoming product units, into a lane of the tray 102 in Block S128. Generally, the central controller 120 can: access a product type of incoming product units (e.g., a box containing loose produce) entering the order fulfillment facility; access a product template for the product type that specifies product-handling parameters (e.g., compatible tray configurations, product types approved for storage with this product type) for the product type in Block S112; select a tray 102, in the population of trays, to temporarily store these incoming product units in Block S120; and trigger the tray-routing system 140 to deliver the tray 102 to the tray-loading station for loading of these incoming product units into the tray 102.

In one implementation, the central controller 120 can: identify a set of trays in the population of trays, each tray 102 in the set of trays including a lane exhibiting a lane geometry compatible with the product type and devoid of product units (or partially devoid of product units); for each tray 102 in the set of trays, access a set of product types of product units occupying the tray 102; in response to presence of conflicts between physical characteristics of product types of product units stored in the tray 102 and the set of physical characteristics of the product type, exclude the tray 102 from a set of candidate trays for storing these incoming product units; in response to absence of conflicts between physical characteristics of product types of product units stored in the tray 102 and the set of physical characteristics of the product type, add the tray 102 to the set of candidate trays; and select a particular tray 102 from the set of candidate trays.

In particular, as shown in FIG. 1A, the central controller 120 can assign a single lane or multiple lanes within a particular tray (e.g., an empty tray or a partially-filled tray) for storing these incoming product units. For example, the central controller 120 can assign a particular lane for storing incoming product units based on physical characteristics (e.g., dimensions, shape, height, and/or weight) of the product type, such that the lane geometry accommodates the dimensions of the product units and the lane stores product units exhibiting similar heights (i.e., when loaded). Additionally or alternatively, the central controller 120 can assign a particular lane for storing incoming product units based on the product classification of the product type, the product classification defining: storage regulations associated with the product type (e.g., separating raw meat, chemicals, produce, and packaged goods into different trays to reduce contamination risk); and/or an allergen classification associated with the product type (e.g., to prevent cross-contact between nut-containing products and allergen-free products).

In one example, the central controller 120: selects a tray 102 (i.e., an empty tray) devoid of product units in each lane in a set of lanes of the tray 102; and assigns a first lane and a second lane, in the set of lanes, for storing incoming product units. In another example, the central controller 120: selects a tray 102 (i.e., a partially-filled tray) devoid of product units in a first lane and temporarily storing product units of a second product type in a second lane (e.g., adjacent the first lane); and assigns the first lane (i.e., an empty lane) for storing incoming product units of a first product type. In particular, in this example, the central controller 120 selects the tray 102 including: the first lane exhibiting a lane geometry compatible with storage of the first product type; and the second lane storing product units of the second product type listed in a list of product types permitted for storage with the first product type.

In yet another example, the central controller 120: selects a tray 102 (i.e., a partially-filled tray) temporarily storing a quantity of extant product units of a first product type in a first lane (i.e., a partially-filled lane), the quantity of product units falling below a maximum capacity of the first lane; and assigns the first lane for storing incoming product units of the first (i.e., the same) product type. Thus, the central controller 120 can dynamically assign product units to partially-filled trays based on real-time tray demand (e.g., a volume of incoming product requiring storage) and available tray capacity. By dynamically assigning product units to empty and/or partially-filled trays, the central controller 120 maximizes allocation of storage slots to high-volume trays (e.g., fully-loaded trays at a maximum storage capacity), thereby minimizing inefficient allocation of storage space.

The central controller 120 can then assign a particular storage slot to temporarily store the tray 102. For example, the central controller 120 can then assign the particular storage slot, such that product units of a particular product type are stored in multiple trays spaced apart throughout the set of storage racks to reduce traffic concentration at a particular dispensing unit 104 for the population of mobile robotic systems 110, and to achieve dispensing unit 104 redundancy (i.e., fault tolerance) whereby the population of mobile robotic systems 110 may retrieve products from one or more alternative dispensing units 104 in the event of a dispensing unit 104 outage. Additionally or alternatively, the central controller 120 can then assign the particular storage slot, such that product units of a popular product type (e.g., eggs, milk, limes) are stored within a storage slot located proximal a dispensing unit 104 to reduce retrieval latency when the tray-routing system 140 retrieves and delivers the tray 102 to the dispensing unit 104.

Additionally or alternatively, the central controller 120 can assign storage slots across a range of targets simultaneously. For example, the central controller 120 can assign storage slots based on sales velocity of each product type, such that high-demand product types are stored proximal dispensing units 104 while low-demand product types are stored in slots further from dispensing units 104, and such that sales velocity is balanced across product types stored within each storage aisle. The central controller 120 can further assign storage slots based on vertical sortation constraints derived from product templates for each product type (e.g., trays 102 storing chemical products occupy lower positions within a tray stack, trays 102 storing unpackaged produce occupy upper positions, and trays 102 storing intermediate product types occupy intervening layers).

### 11.1 Tray Assignment Based on Product Perishability

In one variation, the central controller 120 can assign a tray 102, loaded with product units of a high-demand product type (e.g., commonly-purchased products), to incoming product units of a perishable product type (e.g., highly perishable produce such as berries or leafy greens). In particular, at a dispensing unit 104, during dispensation of product units from a tray 102, the central controller 120 can implement methods and techniques described below: to execute an inspection cycle to detect the quality of product units stored in the tray 102; and to detect triggers (e.g., presence of mold) to remove product units from the tray 102. Thus, the central controller 120 can pair perishable product units (e.g., characterized by a high spoilage rate) with high-demand products to increase the frequency of product inspections (i.e., as trays containing high-demand items may be frequently routed to dispensing units 104).

In this variation, for incoming product units of a perishable product type (e.g., strawberries) characterized by a high spoilage rate (e.g., typically remaining fresh for 3 to 5 days), the central controller 120 can identify a tray 102: devoid of product units in a first lane; and temporarily storing product units of a high-demand product type (e.g., limes) in a second lane. The central controller 120 can then assign the first lane of the tray 102 to temporarily store product units of the perishable product type. More specifically, the central controller 120 can: retrieve a set of historical sales data for the high-demand product type product type; predict a retrieval frequency for a tray 102 storing the high-demand product type based on the set of historical sales data; and, in response to the retrieval frequency exceeding an inspection frequency for the perishable product type, select the tray 102 for storing incoming product units of the of the perishable product type.

Thus, the central controller 120 can assign a particular tray to incoming product units to pair high-demand products with highly-perishable products to maximize inspection frequency for these highly-perishable products. By maximizing inspections of highly-perishable products, the central controller 120 can frequently monitor product quality (e.g., ripeness, presence of mold): to proactively remove spoiled product units to decrease the likelihood of contaminated products accelerating the spoilage of adjacent items; to derive a remaining shelf life for product units to prioritize retrieval of product units nearing expiration; and/or to estimate inventory restocking requirements based on these remaining shelf lives.

### 11.2 Tray Assignment Based on Product Demand

In another variation, the central controller 120 can assign a tray 102, loaded with product units of a high-demand product type (e.g., commonly purchased products such as bananas or bottled water), to incoming product units of a low-demand product type (e.g., specialty items or seasonal products that are infrequently ordered). In this variation, for incoming product units of a low-demand product type, the central controller 120 can identify a tray 102: devoid of product units in a first lane; and temporarily storing product units of a high-demand product type in a second lane. The central controller 120 can then assign the first lane of the tray 102 to temporarily store product units of the low-demand product type.

In particular, the central controller 120 can pair low-demand product units with high-demand product units such that trays containing these low-demand items are frequently routed to dispensing units 104 during fulfillment of orders containing the high-demand products. In one example, the central controller 120 can: store an expiration date of a set of incoming product units; identify a set of candidate trays for storing these incoming product units; for a first tray 102 in the set of candidate trays, predict a retrieval frequency for the first tray 102 based on product types of product units occupying the first tray 102; and, in response to predicting a retrieval frequency that yields retrieval of the first tray 102 prior to the expiration date, select the first tray 102 for storing these incoming product units.

By pairing these low-demand products with high-demand products, the central controller 120 can increase opportunities to inspect, reposition, or remove low-demand product units without increasing tray routing traffic within the order fulfillment facility. For example, during routing of a tray 102 to a dispensing unit 104 for fulfillment of orders containing high-demand products, the central controller 120 can implement methods and techniques described below: to detect product quality issues, expired product units, or misplaced items associated with the low-demand product type; and selectively discard these product units from the tray 102 (e.g., without routing the tray 102 through an additional inspection cycle).

### 11.3 Tray Assignment Based on Product Height

In one variation, the central controller 120 can select the tray 102 based on the product height of the product type of the incoming product units. In this variation, for incoming product units of a first product type (e.g., apples or bell peppers) exhibiting a first product height, the central controller 120 can identify a tray 102: devoid of product units in a first lane in a set of lanes of the tray 102; and temporarily storing product units of a second product type (e.g., lemons or limes) in a second lane, adjacent the first lane in the set of lanes, the second product type exhibiting a second product height within a predefined threshold of the first product height. The central controller 120 can then assign the first lane of the tray 102 to temporarily store product units of the first product type. In this variation, the central controller 120 can assign a particular tray to incoming product units, such that each product unit loaded in the tray 102 exhibits a relatively similar product height. By grouping product units into a tray 102 based on product height, the central controller 120 minimizes wasted vertical storage space in the storage racks.

### 12. Tray Loading+Product-Level Tracking

Blocks of the method S100 recite: in response to a set of incoming product units of the product type entering the order fulfillment facility, accessing a product template that specifies product-handling parameters for product units of the product type at an order fulfillment facility in Block S112; selecting a tray 102, from a population of trays, for storing incoming product units in a set of incoming product units based on a product template for the product type of the set of incoming product units in Block S120; via a tray-routing system 140, navigating the tray 102 to a tray-loading station for loading of product units of the product type into the lane of the tray 102 in Block S130; initializing a first product unit file corresponding to a first product unit in the set of incoming product units in Block S106; and storing a set of locations, occupied by the tray 102 in the first product unit file in Block S108. Generally, in Block S130, upon assigning a lane of a tray 102 for storing incoming product units, the central controller 120 can trigger the tray-routing system 140 to locate the tray 102 in a tray-loading station for loading of product units into the tray 102.

In one implementation, as shown in FIG. 3A, once the tray 102 is loaded with product units, the central controller 120 can, for each product unit: initialize a product unit file corresponding to the product unit; store an intake date, corresponding to a date of entrance of the product unit into the order fulfillment facility, in the product unit file; and store a product address in the product unit file. In particular, the central controller 120 can store the product address specifying: an identifier of the tray 102 assigned to the product unit; a lane identifier of the lane assigned to the product unit; and a position identifier representing a position of the product unit within the lane.

Additionally, the central controller 120 can: assign a storage slot in a set of storage slots of a storage rack, in the population of storage racks, for temporarily storing the tray 102; and, for each product unit stored in the tray 102, append a product address associated with the product unit with a storage rack identifier of the storage rack, and a storage slot identifier of the storage slot. Thus, the central controller 120 can generate a coordinate system for tracking product units within the order fulfillment facility by associating each product unit with an identifier (tray-level tracking), a lane identifier (sub-tray-level tracking), a storage rack identifier (rack-level tracking), and a storage slot identifier (sub-rack-level tracking).

### 12.1 Projected Loading Guidance at Tray-loading Station

In one variation, Block S164 of the method S100 recites projecting a visual representation of a target quantity of product units, oriented in a target loading orientation, onto a tray 102 while the tray 102 occupies the tray-loading station. In this variation, the central controller 120 can: retrieve a virtual representation of a product unit associated with the product type (e.g., from a product model database); retrieve the target loading orientation and the target quantity of product units for storage within a lane of the tray 102 based on the product template; and, via a projection system 190 (e.g., a laser projector, structured-light projector, or digital projection module) located at the tray-loading station, project a visual representation of the target quantity of product units arranged in the target loading orientation onto the tray 102. In particular, the projected visual representation can indicate positions within the lane for placing product units and can visually depict an orientation of the product units relative to the tray 102. Additionally, the central controller 120 can dynamically update the projected visual representation as product units are placed within the tray 102, such as to guide the operator in placing subsequent product units in remaining available positions within the lane.

In another variation, at the tray-loading station (i.e., a manual tray-loading station), the central controller 120 can: generate a visual representation depicting instructions for loading the tray 102 and including a prompt to load incoming product units into the tray 102; and present the visual representation to a worker (e.g., a grocery store stockroom worker) via a user interface (e.g., a display located at the tray-loading station).

### 13. Product Imaging and Inspection

Generally, for a particular product unit, the central controller 120 can execute a series of inspection cycles of the product unit to detect product quality and monitor the product unit for triggers (e.g., presence of mold, wilting, blemishes, and/or damage) to remove the product unit from the tray 102.

In one implementation, during an inspection cycle, the central controller 120 can: trigger an optical sensor 160 (e.g., a hyper-spectral camera, a color camera) to capture an image depicting product units stored in the tray 102; implement edge detection or other computer vision techniques to distinguish singular product units depicted in the image; analyze the image to interpret a product quality of each product unit stored in the tray 102 and depicted in the image; and detect triggers to remove product units from the tray 102 that exhibit a product quality divergent from a target product quality. In particular, the central controller 120 can analyze the image to detect a set of characteristics of the product unit, such as: ripeness (e.g., % of ripeness); a time to peak ripeness (e.g., a prediction for a number of days until the product unit is at peak); a remaining saleable period (e.g., a timeframe within which the product unit retains marketable quality prior to deterioration); presence of internal decay; presence of external mold, wilting, and/or blemishes; and/or a nutrient content. The central controller 120 can then, for a product unit: crop the image to constrain the image to surfaces corresponding to the product unit; and store the image, annotated with a timestamp and a location of the optical sensor 160, and the set of characteristics in the product unit file corresponding to the product unit. Furthermore, the central controller 120 can detect a trigger to remove the product unit from the tray 102 in response to the product unit exhibiting a characteristic deviating from a target characteristic (e.g., a target ripeness).

### 13.1 Post-Loading Inspection

In one variation, the central controller 120 can execute an inspection cycle upon loading of product units into the tray 102 to inspect tray-loading accuracy. In this variation, the central controller 120 can: access an image depicting an actual configuration of product units stored in the tray 102 (e.g., at an imaging station arranged downstream of the tray-loading station); and access a target configuration (e.g., lane assignment, quantity, and product orientation) for product units stored in the tray 102. In response to detecting a discrepancy between the actual configuration and the target configuration, the central controller 120 can trigger the tray-routing system 140 to return the tray 102 to the tray-loading station and render correction instructions to the operator. Alternatively, in response to detecting a discrepancy between the actual configuration and the target configuration, the central controller 120 can update an inventory database to reflect the physical tray configuration (e.g., lane 2 was loaded instead of lane 3).

### 14. Order Fulfillment+Tray Selection

Blocks of the method S100 recite: accessing an electronic order specifying a list of product types in Block S150; selecting a tray 102, containing product units of a product type (or a set of product types) specified in the electronic order, for fulfillment of the electronic order in Block S122; assigning a dispensing unit 104, in the set of dispensing units 104, for dispensation of product units from the tray 102 in Block S154; via the tray-routing system 140, navigating the tray 102 to the dispensing unit 104 in Block S132; and dispensing a product unit of the product type from the tray 102 according to the electronic order via the dispensing unit 104 in Block S160.

Generally, the central controller 120 can: receive an electronic order specifying a quantity of product units of a product type in Block S150; identify a set of trays, in the population of trays, temporarily storing product units of the product type; and select a tray 102 from the set of trays storing product units of the product type in Block S122. The central controller 120 can then: assign a dispensing unit 104, in the set of dispensing units 104, to dispense product units from the tray 102 in Block S154; and trigger the tray-routing system 140 to navigate the tray 102 to the dispensing unit 104 in Block S132. The central controller 120 can then trigger the dispensing unit 104 to dispense the quantity of product units of the product type from the lane of the tray 102 (e.g., into a mobile robotic system 110) according to the electronic order.

### 14.1 Tray Selection Based on Inspection Schedules

In one variation, the central controller 120 can select a particular tray, from a set of trays storing product units of a particular product type specified in the order, based on inspection schedules associated with product units stored in the tray 102, such as to prioritize retrieval of trays containing product units scheduled for inspection or quality verification. In particular, in this variation, the central controller 120 can: maintain inspection schedules for each product unit stored in the order fulfillment facility, such as based on product-handling parameters specified in each product template; access the electronic order specifying the product type; identify a set of trays, in the population of trays, temporarily storing product units of the product type; and select a tray 102, from the set of trays, based on inspection schedules for each product unit stored in the tray 102. More specifically, the central controller 120 can identify a tray 102 storing product units scheduled for inspection within a threshold time period and prioritize selection of this tray for fulfillment of the electronic order such that the tray 102 is routed to a dispensing unit 104 where inspection of the scheduled product units can occur.

In one example, the central controller 120 can: access an electronic order specifying a first product type; identify a set of trays storing product units of the first product type and product units of another product type; retrieve inspection schedules for each product unit stored in these trays; and select a tray 102, from a set of trays loaded with product units of the first product type, for fulfillment of the electronic order and inspection of product units of the second product type based on product-handling parameters specified in the second product template. In particular, in this example, the central controller 120 can identify that product units of the second product type stored in a particular tray are scheduled for inspection based on inspection intervals defined in the second product template. The central controller 120 can therefore prioritize selection of this tray for fulfillment of the electronic order such that, while dispensing product units of the first product type from the tray 102, the system 100 can concurrently inspect product units of the second product type without routing the tray 102 to a separate inspection station.

### 14.2 Tray Selection Based on Stored Product Quantities

In one variation, Block S130 of the method S100 recites, following dispensation of product units from a lane of a tray 102, via the tray-routing system 140, navigating the tray 102 to the tray-loading station for loading of a set of incoming product units into the lane. In this variation, the central controller 120 can select a particular tray, from a set of trays storing product units of a particular product type specified in the order, based on the quantity of product units stored in the lane, such as to prioritize clearing out the lane during fulfillment of the electronic order (i.e., for subsequent reassignment and loading of the lane). In particular, in this variation, the central controller 120 can: receive an electronic order specifying a quantity of product units of a product type; identify a set of trays, in the population of trays, temporarily storing product units of the product type; and select a tray 102, from the set of trays, storing the quantity (i.e., the exact quantity) of product units of the product type within a particular lane of the tray 102. Thus, the central controller 120 can select a tray 102 for dispensation that contains the exact quantity of product units specified in the electronic order to effectively clear out the lane. Additionally, upon dispensation of the product units from the lane, the central controller 120 can: assign incoming product units (i.e., new incoming product units) to the lane; and trigger the tray-routing system 140 to locate the tray 102 in a tray-loading area to receive incoming product units in the lane.

In another variation, the central controller 120 can select a set of (i.e., two or more) trays that, in combination, store the quantity (i.e., the exact quantity) of product units of the product type. Thus, the central controller 120 can effectively clear out both lanes during fulfillment of a single order. By prioritizing clearing out lanes, the central controller 120 accelerates tray turnover (i.e., faster refilling of trays) and minimizes inefficient allocation of storage space to partially-filled trays.

### 14.3 Tray Selection Based on Remaining Saleable Period

In one variation, Block S174 of the method S100 recites deriving a remaining saleable period for a product unit. In this variation, the central controller 120 can select a tray 102, from a set of trays storing product units of a product type specified in an electronic order, based on a remaining saleable period (e.g., a predefined saleable period, a saleable period interpreted during an inspection cycle) of product units of the product type. For example, the remaining saleable period of a product unit can be calculated based on a printed expiration date (e.g., “sell by,” “use by,” “best by”) recorded during product intake (e.g., manually or via optical scanner) and a purge buffer period specific to the product type. In particular, a retailer or fulfillment partner may specify a purge buffer period for a particular product type (e.g., a particular grocer may specify a three-day purge buffer period for milk, whereby the system 100 purges milk units three days prior to its printed expiration date).

In this variation, the central controller 120 can: receive an electronic order specifying a quantity of product units of a first product type; identify a set of trays, in the population of trays, temporarily storing product units of the first product type; and, in response to the tray 102 storing product units of the first product type specified in the electronic order and in response to the saleable period of a product unit of a second product type (i.e., stored in the tray 102) falling within a threshold time period (or expiration of the remaining saleable period), select the tray 102, from the set of trays, for dispensation. Accordingly, the central controller 120 can implement FIFO (first-in, first-out) or FEFO (first-expiry, first-out) inventory strategies to increase product rotation and reduce spoilage. By tracking individual product metadata (e.g., expiration date, intake date, buffer period) and associating these records with tray-level locations, the order fulfillment system can maintain an accurate record of the quantity of product units stored within the order fulfillment facility, when each product unit will expire, and the remaining saleable period of each product unit. Thus, the order fulfillment system can execute proactive order-fulfillment decisions to prioritize movement of product units nearing expiration and interpret future inventory needs based on actual stock and spoilage timing.

### 14.4 Tray Selection Based on Real-time Order Demand

In one variation, the central controller 120 can select a tray 102, from a set of trays storing product units of a product type specified in an electronic order, based on a current order demand of the order fulfillment facility. In particular, the central controller 120 can identify the current order demand of the order fulfillment facility by: accessing a quantity of unfulfilled orders; and, in response to the quantity of unfulfilled orders falling below a threshold quantity (e.g., received within a time interval), identifying a low-demand period at the order fulfillment facility (e.g., during the time interval). Alternatively, in response to the quantity of unfulfilled orders exceeding the threshold quantity, the central controller 120 can identify a high-demand period. In this variation, in response to identifying a low-demand period, the central controller 120 can select a tray 102, from the set of trays, storing the quantity (i.e., the exact quantity) of product units of the product type corresponding to the quantity of product units of the product type specified in the electronic order.

Additionally or alternatively, during a low-demand period, the central controller 120 can select a tray 102 to: remove spoiled product units; and/or proactively remove product units nearing expiration (or expiration of a remaining saleable period). Thus, during a low-demand period, the central controller 120 can prioritize clearing trays to free storage space for incoming inventory and/or to remove expiring or spoiled product units.

Alternatively, during a high-demand period, the central controller 120 can select a tray 102 storing a first quantity of product units of the product type that exceeds a second quantity specified in the electronic order. Thus, during a high-demand period, the central controller 120 can prioritize tray retrieval efficiency by selecting trays with sufficient inventory to fulfill orders in a single retrieval (i.e., to reduce the quantity of tray retrievals).

### 15. Product Inspection+Product Removal During Order Fulfillment

Blocks of the method S100 recite: accessing an image depicting product units stored on a tray 102 in Block S170; detecting a trigger to discard a product unit from a lane of the tray 102 based on features of the product unit depicted in the image in Block S172; and, via the dispensing unit 104, dispensing the product unit responsive to the trigger in Block S160. Generally, as shown in FIGS. 1B and 3A, the central controller 120 can: execute an inspection cycle at a dispensing unit 104 with the tray 102 occupying the dispensing unit 104 (i.e., during fulfillment of an electronic order); store inspection data, recorded during the inspection cycle, in each product unit file corresponding to a product unit stored in the tray 102; and detect triggers to remove product units from the tray 102 based on the inspection data in Block S172.

In one implementation, the central controller 120 can: access an image depicting product units stored on the tray 102 while the tray 102 occupies the dispensing unit 104; and detect a trigger to discard a product unit from the tray 102 based on features of the product unit depicted in the image. For example, the central controller 120 can implement methods and techniques described above to detect a characteristic (e.g., ripeness, mold presence, color, size, damage) of the product unit that deviates from a target characteristic for the product unit. The central controller 120 can then queue discard of the product unit from the tray 102.

In one example, the central controller 120 can: access an electronic order specifying a first product type and a second product type; select a tray 102 storing product units for the first product type and the second product type in response to detecting a trigger to dispense a second product unit of the second product type from the tray 102; assign a dispensing unit 104 to dispense the first product unit and discard the second product unit from the tray 102; dispatch a first mobile robotic system 110 to retrieve the first product unit; and dispatch a second mobile robotic system 110 to retrieve the second product unit. The central controller 120 can then: trigger the dispensing unit 104 to dispense the first product unit into the first mobile robotic system 110 occupying a loading zone proximal the dispensing unit 104 at a first time; and, following dispense of the first product unit into the first mobile robotic system 110, trigger the dispensing unit 104 to dispense the second product unit into a second mobile robotic system 110 occupying the loading zone at a second time. For example, the first mobile robotic system 110 can then navigate the first product unit to a customer retrieval zone while the second mobile robotic system 110 navigates the second product unit to a discard zone. Additionally or alternatively, once the product unit is removed from the tray 102, the central controller 120 can: trigger the tray-routing system 140 to locate the tray 102 in a tray-washing station; and trigger execution of a tray-washing cycle to clean (e.g., sanitize) the tray 102 and/or product units stored in the tray 102.

Thus, the central controller 120 can execute inspection cycles during the dispensation process to increase the frequency of product evaluations, thereby: increasing the likelihood of detecting spoiled or compromised product units prior to these spoiled units reaching consumers; and minimizing the risk of contaminated or deteriorating product units accelerating the spoilage of adjacent inventory.

### 15.1 Automated Handling of Misoriented Product Units

In one variation, Blocks of the method S100 recite: accessing an image captured by an optical sensor 160 proximal the dispensing unit 104, the image depicting product units stored on a tray 102 while the tray 102 occupies the dispensing unit 104 in Block S172; detecting an orientation of a product unit of a product type based on features depicted in the image in Block S192; in response to the orientation of the product unit deviating from a target loading orientation for the product type, verifying dispensability of the product unit according to a set of dispensation parameters for the product type in Block S194; and, in response to non-dispensability of the product unit, disabling the tray 102 for dispensation of product units of the product type and, via the tray-routing system 140, navigating the tray 102 to an inspection station in Block S196. In this variation, the central controller 120 can: detect a product unit stored in the tray 102 at the dispensing unit 104 that deviates from an expected loading orientation; initiate corrective handling of the product unit; and selectively disable dispensing operations for the tray 102 until the product unit is corrected or removed, such that the system 100 avoids attempting to dispense product units in orientations that may cause breakage, jamming, or other dispensing failures.

In particular, for a particular product unit, the central controller 120 can derive: a target loading orientation for loading product units of the product type into a lane of a tray 102; and a set of dispensation parameters for autonomous dispensation of product units of the product type. Then, when a tray 102 storing these product units is loaded into a dispensing unit 104, the central controller 120 can: access an image depicting product units stored on the tray 102 while the tray 102 occupies the dispensing unit 104; detect an orientation of the product unit based on features depicted in the image; and, in response to the orientation of the product unit deviating from the target loading orientation, predict feasibility of dispensing the product unit, at the current orientation, according to the set of existing dispensation parameters.

In one variation, in response to non-dispensability of the product unit, the central controller 120 can: disable the tray 102 for dispensation of product units of the product type; and trigger the tray-routing system 140 to navigate the tray 102 to an inspection station (e.g., for manual reorientation of product units stored on the tray 102). Alternatively, in response to non-dispensability of the product unit, the central controller 120 can derive a new set of dispensation parameters predicted to successfully dispense the product unit at the current orientation and selectively implement the updated set of dispensation parameters for dispensing of the product unit from the tray 102.

In another variation, in response to non-dispensability of the product unit, the central controller 120 can trigger the dispensing unit 104 to attempt to reorient the product unit within the tray 102 via, such as by advancing or retracting the set of dispensing arms to shift the position or orientation of the product unit within the lane. In one example, the central controller 120 can: detect a misoriented product unit (e.g., deviating from an upright orientation expected for dispensing); and trigger the dispensing unit 104 to contact the product unit and shift the product unit toward the target orientation within the lane. In response to the dispensing unit 104 shifting the product unit toward a new orientation compatible with the set of dispensing parameters, the central controller 120 can resume dispensing operations for the tray 102. Conversely, in response to failure to shift the product unit toward a new orientation compatible with the set of dispensing parameters, the central controller 120 can disable the tray 102 for dispensing and route the tray 102 to the inspection station. Thus, the central controller 120 can detect misoriented product units at the dispensing unit 104 and dynamically implement corrective actions or route trays for inspection, thereby preventing dispensing failures and maintaining reliable automated dispensing operations.

### 16. Product Inspection+Product Removal During Storage

In one variation, the central controller 120 can execute a series of inspection cycles of the product unit to detect product quality and monitor the product unit for triggers (e.g., presence of mold, wilting, blemishes, and/or damage), such as while trays (and product units) are in storage racks, on the tray-routing system 140, at inspection stations, etc. In particular, the central controller 120 can access images captured by optical sensors 160 (e.g., hyper-spectral cameras, color cameras) located throughout the order fulfillment facility that depict trays loaded with product units as trays are routed through the facility, stored within storage racks, or positioned at inspection stations.

In this variation, in response to detecting a trigger to remove a product unit from a tray 102, the central controller 120 can: assign a dispensing unit 104, in the set of dispensing units 104, for dispensation of product units temporarily stored in the tray 102; trigger a mobile robotic system 110 to maneuver to a loading zone proximal the dispensing unit 104; trigger the dispensing unit 104 to dispense the product unit from the tray 102 into the mobile robotic system 110; and trigger the mobile robotic system 110 to maneuver to a product removal zone for removal of product units from the mobile robotic system 110. Alternatively, in response to detecting a trigger to remove a product unit from a tray 102, the central controller 120 can trigger the tray-routing system 140 to maneuver the tray 102 to the product removal zone for removal (e.g., autonomous or manual removal) of the product unit from the tray 102.

### 17. Audit Trail

In one variation, Blocks of the method S100 recite: identifying a set of locations occupied by a tray 102 storing a recalled product unit based on a product file corresponding to a recalled product unit associated with a recall event in Block S180; identifying a set of affected trays occupying locations within the threshold distance of the set of locations of the tray 102 in Block S182; aggregating a list of customer identifiers associated with electronic orders containing affected product units stored in the set of affected trays in Block S184; generating a notification indicating the recall event in Block S186; and serving the notification to the list of customer identifiers in Block S188.

In one variation, as shown in FIGS. 3A and 3B, the central controller 120 can reconstruct an audit trail for a particular product unit based on product movements recorded in the corresponding product unit file. In particular, for each incoming product unit, the central controller 120 can implement methods and techniques described above to store a set of locations, occupied by a tray 102 storing the product unit, in a product unit file corresponding to the product unit. For example, the product unit file can contain locations of the tray 102 recorded throughout the order fulfillment facility, such as at dispensing units 104, in storage racks, on the tray-routing system 140, at inspection stations, etc. The central controller 120 can then: store this product unit file in a database of product unit files that represents locations of each product unit stored in the facility; and, in response to receipt of a recall notice, query the database of product unit files to identify trays (and product units) located in proximity with a recalled product unit.

For example, in response to a recall event for a recalled product unit, the central controller 120 can: access a product unit file corresponding to the recalled product unit; extract a batch identifier of the product unit from the product unit file; identify product units, stored in the order fulfillment facility, associated with the batch identifier; and implement methods and techniques described above to automatically trigger discard of these product units.

In another example, in response to a recall event for a recalled product unit, the central controller 120 can: access a product unit file corresponding to the recalled product unit; extract a set of locations occupied by the tray 102 storing the recalled product unit; identify a set of affected trays (e.g., potentially contaminated trays), each affected tray occupying a location within a threshold distance of the set of locations of the tray 102; and identify a set of affected product units (e.g., potentially contaminated product units), stored in the set of affected trays, during storage of the recalled product unit. For example, the central controller 120 can define the threshold distance based on a contamination risk associated with a recall classification of the recalled product unit.

Additionally, in this example, the central controller 120 can identify a first subset of product units, in the set of affected product units, located outside the order fulfillment facility (e.g., dispensed and sold to customers). The central controller 120 can then, for each product unit in the first subset of product units: access an electronic order corresponding to the product unit; and extract a customer identifier (e.g., an email address) associated with the electronic order. The central controller 120 can then: aggregate a list of customer identifiers associated with each order containing an affected product unit; generate a notification indicating the recall event and presence of an affected product unit in the electronic order; and serve the notification to the list of customer identifiers.

Additionally or alternatively, in this example, the central controller 120 can: identify a second subset of product units, in the set of affected product units, located within the order fulfillment facility (i.e., currently in storage); and implement methods and techniques described above to inspect, clean, and/or remove these product units. For example, in response to detecting a first position of a first tray 102, storing a first product unit, falling within a threshold distance of a second position of a second tray 102 storing the recalled product unit, the central controller 120 can: detect a trigger to discard the first product unit; and implement methods and techniques described above to assign a dispensing unit 104 to discard the product unit from the first tray 102.

In another example, responsive to receipt of a customer complaint related to a missing or spoiled item, the central controller 120 can access the product unit file corresponding to the product unit to investigate the reported issue. For example, the central controller 120 can: identify whether the unit was dispensed successfully or stored adjacent a leaking or damaged item; and confirm (or refute) the claim based on recorded inspection data and tray interactions.

In one variation, each product unit file can further include environmental condition data, such as temperature and humidity readings, recorded at each storage location occupied by the tray 102. Additionally or alternatively, each product unit file can further include a source identifier referencing the original product case, distributor, or farm from which the product unit originated. In this variation, the central controller 120 can detect patterns in product degradation linked to environmental conditions and/or specific sources, and flag products at a relatively higher risk of early spoilage.

### 18. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
generating a first product template specifying product-handling parameters for a first product type;
during a first time period:
in response to a first set of incoming product units of the first product type entering an order fulfillment facility, accessing the first product template for the first product type;
selecting a first tray, from a population of trays, for storing incoming product units in the first set of incoming product units based on the first product template, the first tray comprising:
a first lane devoid of product units; and
a second lane occupied by product units of a second product type;
queuing placement of a first quantity of product units, in the first set of incoming product units, into the first lane of the first tray; and
via a tray-routing system, navigating the first tray to a tray-loading station for loading of product units of the first product type into the first lane of the first tray; and
during a second time period succeeding the first time period:
accessing an electronic order specifying the second product type;
selecting the first tray, from a set of trays loaded with product units of the second product type, for fulfillment of the electronic order and inspection of product units of the first product type based on product-handling parameters specified in the first product template;
via the tray-routing system, navigating the first tray to a dispensing unit for dispensation of product units from the first tray;
via the dispensing unit, dispensing a second product unit of the second product type from the second lane according to the electronic order;
detecting a trigger to discard a first product unit of the first product type from the first tray; and
via the dispensing unit, dispensing the first product unit responsive to the trigger.

2. The method of claim 1:
further comprising, during the second time period, deriving a remaining saleable period for the first product unit;
wherein detecting the trigger to discard the first product unit from the first tray comprises:
detecting the trigger to discard the first product unit from the first tray based on expiration of the remaining saleable period for the first product unit; and
wherein selecting the first tray, from the set of trays loaded with product units of the second product type, during the second time period comprises:
in response to detecting the trigger to discard the first product unit of the first product type from the first tray, selecting the first tray from the set of trays.

3. The method of claim 1:
wherein generating the first product template comprises:
generating the first product template specifying product-handling parameters for the first product type comprising a perishable product type, the first product template specifying:
an inspection frequency for the perishable product type; and
wherein selecting the first tray, from the population of trays, for storing incoming product units during the first time period comprises:
retrieving a set of historical sales data for the second product type;
predicting a retrieval frequency for the first tray based on the set of historical sales data; and
in response to the retrieval frequency exceeding the inspection frequency for the perishable product type:
selecting the first tray for storing incoming product units in the first set of incoming product units.

4. The method of claim 1:
wherein selecting the first tray, from the set of trays loaded with product units of the second product type, during the second time period comprises:
in response to a first expiration date of product units stored in the first tray approaching, selecting the first tray from the set of trays; and
wherein detecting the trigger to discard the first product unit from the first tray comprises:
accessing an image captured by an optical sensor proximal the dispensing unit, the image depicting product units stored on the first tray while the first tray occupies the dispensing unit;
detecting a characteristic of the first product unit based on features of the first product unit depicted in the image; and
in response to the characteristic deviating from a target characteristic for the first product unit, detecting the trigger to discard the first product unit.

5. The method of claim 1:
wherein generating the first product template comprises:
accessing a first set of physical characteristics and a first product classification of the first product type;
deriving a first lane geometry compatible with the first product type based on the first set of physical characteristics;
deriving a first set of dispensation parameters for autonomous dispensation of product units of the first product type based on the first set of physical characteristics;
generating the first product template specifying:
the first lane geometry; and
the first set of dispensation parameters; and
storing the first product template, labeled with the first set of physical characteristics and the first product classification, in a product template database containing a population of product templates; and
wherein selecting the first tray, from the population of trays, for storing incoming product units during the first time period comprises:
identifying a set of trays in the population of trays, each tray in the set of trays comprising a lane:
exhibiting the first lane geometry; and
devoid of product units;
for each tray in the set of trays:
accessing a set of product types of product units occupying the tray;
in response to presence of conflicts between physical characteristics of product types of product units stored in the tray and the first set of physical characteristics of the first product type:
excluding the tray from a set of candidate trays for storing incoming product units in the first set of incoming product units; and
in response to absence of conflicts between physical characteristics of product types of product units stored in the tray and the first set of physical characteristics of the first product type:
adding the tray to the set of candidate trays; and
selecting the first tray from the set of candidate trays.

6. The method of claim 1, wherein generating the first product template comprises:
accessing a first set of physical characteristics of the first product type;
scanning a product template database for product templates labeled with physical characteristics corresponding to the first set of physical characteristics;
in response to correspondence between the first set of physical characteristics and a third set of physical characteristics of a third product type, populating the first product template with product-handling parameters specified in a third product template for the third product type including:
a third lane geometry compatible with the third product type; and
a third set of dispensation parameters for autonomous dispensation of product units of the third product type; and
in response to absence of a first product classification of the first product type:
generating a prompt to specify a first list of product types permitted for storage with the first product type; and
serving the prompt to an operator.

7. The method of claim 1, wherein generating the first product template comprises:
accessing a first product classification of the first product type;
scanning a product template database for product templates labeled with product classifications corresponding to the first product classification;
in response to correspondence between the first product classification and a third product classification of a third product type, populating the first product template with product-handling parameters specified in a third product template for the third product type including:
a third list of product types permitted for storage with the third product type; and
in response to absence of a first set of physical characteristics of the first product type:
generating a prompt to specify:
a first lane geometry compatible with the first product type; and
a first set of dispensation parameters for autonomous dispensation of product units of the first product type; and
serving the prompt to an operator.

8. The method of claim 1, wherein generating the first product template comprises:
accessing an image captured by an optical sensor at the order fulfillment facility, the image depicting the first set of incoming product units;
detecting a first set of physical characteristics of the first product type based on the image;
generating a first embedding encoding the first set of physical characteristics of the first product type;
accessing a product model database containing a population of embeddings, each embedding encoding a set of physical characteristics of a product type and a lane geometry compatible with the product type;
identifying a third embedding, in the population of embeddings, characterized by a shortest distance to the first embedding; and
populating the first product template with a third lane geometry embedded in the third embedding.

9. The method of claim 1:
wherein generating the first product template comprises:
scanning a product model database for virtual product models labeled with physical characteristics corresponding to a first set of physical characteristics of the first product type;
in response to correspondence between the first set of physical characteristics and a third set of physical characteristics of a third product type, accessing a third virtual product model for the third product type from the product model database;
accessing a virtual tray model of a virtual tray representing a virtual lane compatible with the first product type;
based on the third virtual product model and the virtual tray model, deriving a first target loading orientation for loading a first target quantity of product units of the first product type into a lane of a tray exhibiting a first lane geometry; and
generating the first product template specifying:
the first target loading orientation; and
the first target quantity; and
further comprising:
projecting a visual representation of the first target quantity of product units, oriented in the first target loading orientation, onto the first tray, via a projection system arranged over the tray-loading station, while the first tray occupies the tray-loading station.

10. The method of claim 1, wherein generating the first product template comprises:
accessing a product template database containing a population of product templates;
scanning the product template database for product templates labeled with product metadata corresponding to a first set of product metadata of the first product type;
in response to correspondence between the first set of product metadata and a third set of product metadata of a third product type, accessing a third set of product-handling parameters specified in a third product template for the third product type;
accessing a set of characteristics of the order fulfillment facility;
interpreting a first subset of product-handling parameters, in the third set of product-handling parameters, incompatible with storage at the order fulfillment facility based on the set of characteristics of the order fulfillment facility;
populating the first product template with a second subset of product-handling parameters excluding the first subset of product-handling parameters;
generating a prompt to specify product-handling parameters in the first subset of product-handling parameters;
serving the prompt to an operator; and
populating the first product template with product-handling parameters specified by the operator.

11. The method of claim 1:
wherein generating the first product template comprises generating the first product template specifying a location of an expiration date on packaging of product units of the first product type;
further comprising:
in response to presence of the first tray and the first set of incoming product units at the tray-loading station, presenting the location of the expiration date to an operator via a user interface at the tray-loading station; and
storing a first expiration date of the first set of incoming product units; and
wherein selecting the first tray, from the population of trays, for storing incoming product units during the first time period comprises:
predicting a retrieval frequency for the first tray based on product types of product units occupying the first tray, the retrieval frequency predicted to yield retrieval of the first tray prior to the first expiration date; and
in response to the retrieval frequency yielding retrieval of the first tray prior to the first expiration date:
selecting the first tray for storing incoming product units in the first set of incoming product units.

12. The method of claim 1:
wherein accessing the electronic order during the second time period comprises:
accessing the electronic order specifying a second quantity of product units of the second product type;
wherein selecting the first tray, from the set of trays loaded with product units of the second product type, during the second time period comprises:
in response to the first tray storing the second quantity of product units in the second lane, selecting the first tray from the set of trays; and
further comprising, during the second time period:
following dispensation of the second quantity of product units from the second lane, via the tray-routing system, navigating the first tray to the tray-loading station for loading of a third set of incoming product units into the second lane.

13. The method of claim 1:
wherein dispensing the first product unit via the dispensing unit during the second time period comprises:
dispensing the first product unit from the first lane into a first mobile robotic system for delivery to a discard zone; and
wherein dispensing the second product unit via the dispensing unit during the second time period comprises:
dispensing the second product unit from the second lane into a second mobile robotic system for delivery to a customer retrieval zone.

14. The method of claim 1:
wherein generating the first product template comprises generating the first product template specifying:
a first target loading orientation for loading product units of the first product type into a lane of a tray; and
a first set of dispensation parameters for autonomous dispensation of product units of the first product type; and
further comprising, during the second time period:
accessing an image captured by an optical sensor proximal the dispensing unit, the image depicting product units stored on the first tray while the first tray occupies the dispensing unit;
detecting an orientation of a third product unit of the first product type, stored in the first lane, based on features depicted in the image;
in response to the orientation of the third product unit deviating from the first target loading orientation, verifying dispensability of the third product unit according to the first set of dispensation parameters; and
in response to non-dispensability of the third product unit:
disabling the first lane of the first tray for dispensation of product units of the first product type; and
via the tray-routing system, navigating the first tray to an inspection station.

15. The method of claim 1:
further comprising:
initializing a first product unit file corresponding to the first product unit;
storing a first set of locations, occupied by the first tray storing the first product unit, in the first product unit file;
accessing a second product unit file corresponding to a recalled product unit associated with a recall event; and
identifying a second set of locations occupied by a second tray storing the recalled product unit based on the second product unit file; and
wherein detecting the trigger to discard the first product unit from the first tray during the second time period comprises:
in response to detecting a first position of the first tray falling within a threshold distance of a second position of the second tray, detecting the trigger to discard the first product unit.

16. A method comprising:
during a first time period:
in response to a first set of incoming product units of a first product type entering an order fulfillment facility, accessing a first product template specifying product-handling parameters for product units of the first product type;
assigning a first lane of a tray, in a population of trays, for storing incoming product units in the first set of incoming product units based on the first product template; and
via a tray-routing system, navigating the tray to a tray-loading station for loading of a first quantity of product units, in the first set of incoming product units, into the first lane of the tray; and
during a second time period succeeding the first time period:
accessing an electronic order specifying the first product type;
accessing an image depicting product units stored on the tray;
detecting a trigger to discard a second product unit stored in a second lane, adjacent the first lane, of the tray based on features of the second product unit depicted in the image;
in response to detecting the trigger to discard the second product unit:
selecting the tray, from a set of trays loaded with product units of the first product type, for fulfillment of the electronic order;
via the tray-routing system, navigating the tray to a dispensing unit for dispensation of product units from the tray; and
via the dispensing unit:
dispensing a first product unit of the first product type from the first lane according to the electronic order; and
dispensing the second product unit from the second lane of the tray.

17. The method of claim 16, further comprising:
accessing a product template database containing a population of product templates;
scanning the product template database for product templates labeled with product metadata corresponding to a first set of product metadata of the first product type;
in response to correspondence between the first set of product metadata and a third set of product metadata of a third product type, accessing a third set of product-handling parameters specified in a third product template for the third product type and including:
a first set of storage parameters; and
a first set of dispensation parameters for autonomous dispensation of product units of the first product type; and
generating the first product template specifying:
the first set of storage parameters; and
the first set of dispensation parameters.

18. The method of claim 16:
wherein accessing the first product template for the first product type during the first time period comprises:
accessing the first product template specifying an inspection frequency for the first product type; and
wherein assigning the first lane of the tray for storing incoming product units during the first time period comprises:
retrieving a set of historical sales data for a second product type of product units stored in the tray;
predicting a retrieval frequency for the tray based on the set of historical sales data; and
in response to the retrieval frequency exceeding the inspection frequency for the first product type:
assigning the first lane of the tray for storing incoming product units.

19. The method of claim 16:
wherein accessing the image depicting product units stored on the tray during the second time period comprises accessing the image captured by an optical sensor proximal the dispensing unit;
wherein detecting the trigger to discard the second product unit during the second time period comprises:
detecting a characteristic of the second product unit based on features of the second product unit depicted in the image; and
in response to the characteristic deviating from a target characteristic for the second product unit, detecting the trigger to discard the second product unit;
wherein dispensing the first product unit from the first lane during the second time period comprises, via the dispensing unit, dispensing the first product unit into a first mobile robotic system; and
wherein dispensing the second product unit from the second lane during the second time period comprises, via the dispensing unit, dispensing the second product unit into a second mobile robotic system following dispensation of the first product unit.

20. A method comprising:
during a first time period:
in response to a first set of incoming product units of a first product type entering an order fulfillment facility, accessing a first product template that specifies product-handling parameters for product units of the first product type at the order fulfillment facility;
assigning a first lane of a tray, in a population of trays, for storing incoming product units in the first set of incoming product units based on the first product template; and
queuing placement of a first quantity of product units, in the first set of incoming product units, into the first lane of the tray; and
during a second time period succeeding the first time period:
accessing an electronic order specifying the first product type;
selecting the tray, from a set of trays loaded with product units of the first product type, for fulfillment of the electronic order based on product-handling parameters specified in the first product template;
assigning a dispensing unit, located within the order fulfillment facility, for dispensation of product units from the tray;
via the dispensing unit, dispensing a first product unit of the first product type from the first lane according to the electronic order;
detecting a trigger to discard a second product unit from a second lane, adjacent the first lane, of the tray; and
queuing discard of the second product unit from the tray.
